(19) United States
(12) Patent Application Publication
(10) Pub. No.: US 2022/0238083 A1
(43) Pub. Date: Jul. 28, 2022

(54) INFORMATION PROCESSING DEVICE, AND DISPLAY METHOD

(71) Applicant: Mitsubishi Electric Corporation, Tokyo (JP)

(72) Inventors: Kotoyu SASAYAMA, Tokyo (JP); Kei GOMITA, Tokyo (JP); Kazuki JOE, Nara (JP)

(73) Assignee: Mitsubishi Electric Corporation, Tokyo (JP)

(21) Appl. No.: 17/717,755

(22) Filed: Apr. 11, 2022

Related U.S. Application Data
(63) Continuation of application No. PCT/JP2020/028668, filed on Jul. 27, 2020.

(30) Foreign Application Priority Data
Nov. 29, 2019 (JP) 2019-217266

(51) Int. Cl. G09G 5/38; B60K 35/00; G06F 3/01

(52) U.S. Cl. CPC G09G 5/38; B60K 35/00; G06F 3/015; G09G 2380/10; B60K 2370/12; B60Y 2200/11; G09G 2340/0492; B60K 2370/52

(57) ABSTRACT

An information processing device includes an acquisition unit and a control unit. The acquisition unit acquires prediction information indicating whether or not a mobile object is scheduled to rotate at a first place. The control unit makes a display device display motion sickness prevention information moving in a first direction based on a direction in which the mobile object is scheduled to rotate or in a direction opposite to the first direction before the mobile object reaches the first place when the prediction information indicates that the mobile object is scheduled to rotate at the first place.

### CROSS-REFERENCE TO RELATED APPLICATION

This application is a Continuation of PCT International Application No. PCT/JP2020/028668, filed on Jul. 27, 2020, which claims priority under 35 U.S.C. § 119(a) to Patent Application No. 2019-217266, filed in Japan on Nov. 29, 2019, all of which are hereby expressly incorporated by reference into the present application.

### BACKGROUND OF THE INVENTION

### 1. Field of the Invention

The present disclosure relates to an information processing device, and a display method.

### 2. Description of the Related Art

A passenger of a conveyance such as an automobile or a ship can suffer from motion sickness. The passenger feels sick especially when the passenger is looking at an in-vehicle display or a smartphone. The sensory conflict theory is dominant in regard to the mechanism of the occurrence of the motion sickness. The motion sickness disturbs a time of comfort. Thus, prevention of the motion sickness is being requested. For example, the passenger can prevent the motion sickness by taking a motion sickness drug. Here, another method for preventing the motion sickness has been proposed (see Non-patent Reference 1).

Non-patent Reference 1: “Diminished Reality for Acceleration Stimulus: Motion Sickness Reduction with Vection for Autonomous Driving” Taishi Sawabe, Masayuki Kanbara, Norihiro Hagita

Incidentally, there is a case where information for adjusting the sense of speed for preventing the motion sickness and an arrow indicating the traveling direction as prediction information for preventing the motion sickness are displayed at the same time. By this display, an information overload is caused and at the same time the visual field is obstructed. Therefore, carrying out the display impairs the comfortability.

### SUMMARY OF THE INVENTION

An object of the present disclosure is to increase the comfortability.

An information processing device according to an aspect of the present disclosure is provided. The information processing device includes an acquisition unit that acquires prediction information indicating whether or not a mobile object is scheduled to rotate at a first place and a control unit that makes a display device display motion sickness prevention information moving in a first direction based on a direction in which the mobile object is scheduled to rotate or in a direction opposite to the first direction before the mobile object reaches the first place when the prediction information indicates that the mobile object is scheduled to rotate at the first place.

According to the present disclosure, the comfortability can be increased.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a block diagram showing function of an information processing device in a first embodiment;

FIG. 2 is a diagram showing the configuration of hardware included in the information processing device in the first embodiment;

FIG. 3 is a diagram showing an example of a region where motion sickness prevention information is displayed in the first embodiment;

FIGS. 4(A) and 4(B) are diagrams (No. 1) showing concrete examples of the motion sickness prevention information in the first embodiment;

FIGS. 5(A) and 5(B) are diagrams (No. 2) showing concrete examples of the motion sickness prevention information in the first embodiment;

FIG. 6 is a flowchart showing an example of a process executed by the information processing device in the first embodiment;

FIGS. 7(A) and 7(B) are diagrams (No. 1) for explaining a direction of movement of the motion sickness prevention information in the first embodiment;

FIG. 8 is a diagram (No. 1) showing a concrete example of the direction of the movement of the motion sickness prevention information in the first embodiment;

FIGS. 9(A) and 9(B) are diagrams (No. 2) for explaining the direction of the movement of the motion sickness prevention information in the first embodiment;

FIGS. 10(A) and 10(B) are diagrams (No. 3) for explaining the direction of the movement of the motion sickness prevention information in the first embodiment;

FIG. 11 is a diagram (No. 2) showing a concrete example of the direction of the movement of the motion sickness prevention information in the first embodiment;

FIGS. 12(A) and 12(B) are diagrams (No. 4) for explaining the direction of the movement of the motion sickness prevention information in the first embodiment;

FIGS. 13(A) and 13(B) are diagrams (No. 5) for explaining the direction of the movement of the motion sickness prevention information in the first embodiment;

FIGS. 14(A) and 14(B) are diagrams (No. 6) for explaining the direction of the movement of the motion sickness prevention information in the first embodiment;

FIG. 15 is a diagram (No. 1) for explaining a display range of the motion sickness prevention information;

FIG. 16 is a diagram (No. 2) for explaining the display range of the motion sickness prevention information;

FIG. 17 is a diagram showing a concrete example of the direction of the movement of the motion sickness prevention information when an automobile makes a right turn and a left turn in the first embodiment;

FIG. 18 is a diagram (No. 3) showing a concrete example of the direction of the movement of the motion sickness prevention information in the first embodiment;

FIG. 19 is a diagram (No. 1) for explaining the display in a central visual field in the first embodiment;

FIGS. 20(A) and 20(B) are diagrams (No. 2) for explaining the display in the central visual field in the first embodiment;

FIGS. 21(A) to 21(C) are diagrams showing concrete examples regarding a method for not displaying the motion sickness prevention information in the vicinity of the automobile in the first embodiment;

FIG. 22 is a diagram for explaining the display of the motion sickness prevention information in the first embodiment;

FIG. 23 is a block diagram showing function of an information processing device in a second embodiment;

FIG. 24 is a flowchart showing an example of a judgment process using a current motion sickness level in the second embodiment;

FIG. 25 is a flowchart showing an example of a judgment process using a future motion sickness level in the second embodiment;

FIG. 26 is a block diagram showing function of an information processing device in a third embodiment;

FIG. 27 is a diagram showing a concrete example of the display of the motion sickness prevention information in the third embodiment;

FIG. 28 is a block diagram showing function of an information processing device in a fourth embodiment;

FIG. 29 is a flowchart showing an example of a process executed by the information processing device in the fourth embodiment;

FIG. 30 is a block diagram showing function of an information processing device in a fifth embodiment;

FIG. 31 is a flowchart showing an example of a judgment process using the current motion sickness level in the fifth embodiment;

FIG. 32 is a flowchart showing an example of a judgment process using the future motion sickness level in the fifth embodiment; and

FIG. 33 is a block diagram showing function of an information processing device in a sixth embodiment.

### DETAILED DESCRIPTION OF THE INVENTION

Embodiments will be described below with reference to the drawings. The following embodiments are just examples and a variety of modifications are possible within the scope of the present disclosure.

### First Embodiment

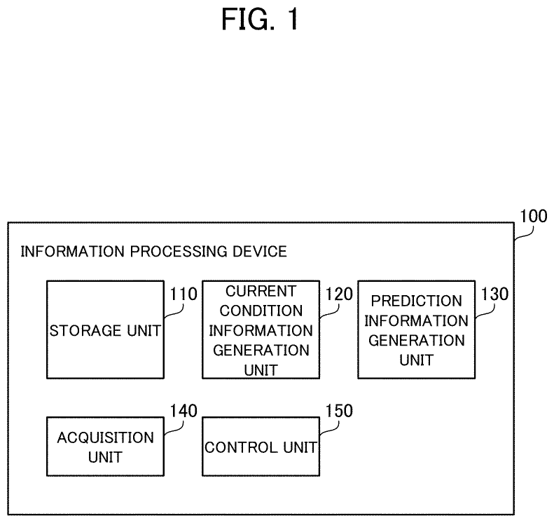

FIG. 1 is a block diagram showing function of an information processing device in a first embodiment. The information processing device 100 is a device that executes a display method. The information processing device 100 may be regarded as an in-vehicle device. The information processing device 100 is assumed to be placed in an automobile driven by a driver or an automobile performing automated driving. Further, the driving by a driver can be referred to as manual driving. Furthermore, the automobile is referred to also as a mobile object.

The information processing device 100 includes a storage unit 110, a current condition information generation unit 120, a prediction information generation unit 130, an acquisition unit 140 and a control unit 150.

Here, hardware included in the information processing device 100 will be described below.

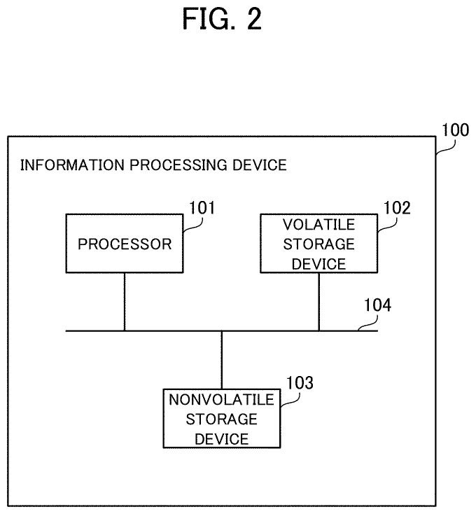

FIG. 2 is a diagram showing the configuration of the hardware included in the information processing device in the first embodiment. The information processing device 100 includes a processor 101, a volatile storage device 102 and a nonvolatile storage device 103. The processor 101, the volatile storage device 102 and the nonvolatile storage device 103 are connected together by a bus 104.

The processor 101 controls the whole of the information processing device 100. For example, the processor 101 is a Central Processing Unit (CPU), a Field Programmable Gate Array (FPGA) or the like. The processor 101 can also be a multiprocessor. The information processing device 100 may also be implemented by a processing circuitry or implemented by software, firmware or a combination of software and firmware. Incidentally, the processing circuitry may be either a single circuit or a combined circuit.

The volatile storage device 102 is main storage of the information processing device 100. The volatile storage device 102 is a Random Access Memory (RAM), for example. The nonvolatile storage device 103 is auxiliary storage of the information processing device 100. The nonvolatile storage device 103 is a Solid State Drive (SSD), for example.

Returning to FIG. 1, the function of the information processing device 100 will be described below.

The storage unit 110 may be implemented as a storage area secured in the volatile storage device 102 or the nonvolatile storage device 103.

Part or all of the current condition information generation unit 120, the prediction information generation unit 130, the acquisition unit 140 and the control unit 150 may be implemented by the processor 101. Part or all of the current condition information generation unit 120, the prediction information generation unit 130, the acquisition unit 140 and the control unit 150 may be implemented as modules of a program executed by the processor 101. For example, the program executed by the processor 101 is referred to also as a display program. The display program has been recorded in a record medium, for example.

The storage unit 110 stores a variety of information. For example, the storage unit 110 stores route information. For example, the route information is information generated based on an input of a destination by a user.

The current condition information generation unit 120 generates current condition information. The current condition information generation unit 120 may generate current condition information indicating a current position of the automobile, a current position of a passenger, vicinal information, traveling condition including the current speed of the automobile, and condition of the passenger.

Incidentally, the current position of the automobile is identified based on information acquired from a vehicle-outside camera, information acquired from a Global Positioning System (GPS), information acquired from a sensor such as an acceleration sensor or a gyro sensor, and map data. The vicinal information is obtained by using a vehicle-outside camera, sonar, an ultrasonic sensor, a millimeter-wave radar or the like. Specifically, the vicinal information is information indicating positions, speeds, types and the like of obstacles such as vicinal vehicles and pedestrians.

The vehicle-outside camera is capable of capturing images of scenery. Information obtained by the image capturing of the scenery by the vehicle-outside camera is referred to also as information indicating the scenery. The information indicating the scenery is referred to as a fluid stimulus. The fluid stimulus may also be generated by a device other than the vehicle-outside camera.

The traveling condition is identified by using operation information acquired from a Controller Area Network (CAN) or the like. Specifically, the traveling condition is information regarding the accelerator, the brake, the steering operation and so forth. The condition of the passenger is identified based on information acquired from a driver monitoring system. Incidentally, this information is information indicating current condition of the passenger such as a concentration level, a sleepiness level and a motion sickness level, for example.

In a case where a travel route has previously been determined, the current condition information generation unit 120 may generate information indicating the travel route. Further, the current condition information generation unit 120 may generate the current condition information by using a conventional technology. The current condition information generation unit 120 may calculate a rotation direction represented by roll, pitch and yaw, a rotation direction with reference to a different rotation axis, a frequency, an angular speed, amplitude, and the like based on the current condition information. The storage unit 110 may accumulate the calculated information as time-series data.

Further, the current condition information generation unit 120 generates information indicating current movement of the fluid stimulus. In other words, the current condition information generation unit 120 generates information indicating a current flow of the scenery. For example, the current condition information generation unit 120 generates the information indicating the current movement of the fluid stimulus based on information acquired from the vehicle-outside camera. Incidentally, the information indicating the current movement of the fluid stimulus is information indicating a direction opposite to a direction in which the automobile is currently moving. Furthermore, the current condition information generation unit 120 may generate information including information indicating past movement of the fluid stimulus and the information indicating the current movement of the fluid stimulus.

The prediction information generation unit 130 generates prediction information. The prediction information is information indicating whether or not the automobile is scheduled to rotate at a first place. The prediction information may also be expressed as follows: The prediction information is information indicating whether or not the automobile is scheduled to change moving direction or traveling direction at the first place. Further, the prediction information is time-series data indicating how the automobile rotates in the case where the automobile is scheduled to rotate.

Here, the case where the automobile rotates can be a case where the automobile travels on an uneven road, a case where the automobile travels while leaning to the left or right, a case where the automobile makes a left turn or a right turn, a case where acceleration occurs, a case where the legal speed changes, a case where the automobile traveling on an expressway exits to an ordinary road while traveling on a rotary road, or the like. It is possible to set a threshold value for judging whether the automobile rotates or not based on the rotation direction, a rotation angle, the frequency, the angular speed, the amplitude, the acceleration, the speed, or the like.

A method for generating the prediction information will be described below. The prediction information generation unit 130 acquires the current position of the automobile from the current condition information generation unit 120. The prediction information generation unit 130 generates the prediction information based on the current position of the automobile and the first place included in the route information. For example, when the first place included in the route information is a place to make a left turn or a right turn, the prediction information generation unit 130 generates prediction information indicating that the automobile is scheduled to rotate at the first place.

The prediction information generation unit 130 may also generate the prediction information as follows: Information regarding roll, pitch and yaw has been associated with the first place included in the route information. The prediction information generation unit 130 generates the prediction information by using the information regarding roll, pitch and yaw. For example, the prediction information generation unit 130 can identify that the automobile makes a left turn or a right turn at the first place by using values based on roll, pitch and yaw at the first place and reference values. When the prediction information generation unit 130 successfully identified that the automobile makes a left turn or a right turn at the first place, the prediction information generation unit 130 generates prediction information indicating that the automobile is scheduled to make a left turn or a right turn at the first place.

Here, information indicating times of day have been associated with the current position of the automobile and the first place included in the route information. The prediction information generation unit 130 calculates the angular speed by using the current position, the first place and a time based on the times of day. When the angular speed is other than 0, the prediction information generation unit 130 generates prediction information indicating that the automobile is scheduled to rotate at the first place. Further, the prediction information generation unit 130 may calculate the acceleration based on the angular speed. When the acceleration is not 0, the prediction information generation unit 130 may generate prediction information indicating that the automobile is scheduled to rotate at the first place. The prediction information generation unit 130 may generate prediction information based on an altitude and the angular speed.

Further, the prediction information generation unit 130 may generate prediction information based on the current movement of the fluid stimulus.

In a case where the storage unit 110 has not stored the route information, the prediction information generation unit 130 may generate the prediction information as follows: First, the storage unit 110 has previously stored information indicating that the automobile rotates at the first place. The prediction information generation unit 130 acquires the current position of the automobile from the current condition information generation unit 120. If the distance between the current position and the first place is less than or equal to a predetermined threshold value, the prediction information generation unit 130 generates prediction information indicating that the automobile is scheduled to rotate at the first place. Further, the prediction information generation unit 130 may generate the prediction information indicating that the automobile is scheduled to rotate at the first place based on an image of a curve captured by the vehicle-outside camera and information, generated by the current condition information generation unit 120, indicating that the brake pedal is currently pressed.

The prediction information generation unit 130 may predict movement of the passenger. The prediction information generation unit 130 may calculate the speed or the acceleration of the automobile at a future time by using the route information. The prediction information generation unit 130 may predict movement of the automobile at a future time based on an image obtained by the image capturing by the vehicle-outside camera and the route information.

Further, the prediction information generation unit 130 may predict on which part of the road the automobile will travel based on the route information including a road width, driving characteristics of the driver, driving history records of the driver, road conditions, or the like. The prediction information generation unit 130 may generate prediction information based on a plurality of intervals, such as a time that is a seconds after the present time point and a time that is @seconds after the time a seconds after the present time point. The prediction information generation unit 130 may process the prediction information.

The acquisition unit 140 acquires the prediction information from the prediction information generation unit 130. The acquisition unit 140 may acquire the prediction information from an external device connectable to the information processing device 100.

When the prediction information indicates that the automobile is scheduled to rotate at the first place, the control unit 150 makes a display device display motion sickness prevention information, moving in a direction based on a direction in which the automobile is scheduled to rotate, before the automobile reaches the first place. In other words, when the prediction information indicates that the automobile is scheduled to rotate at the first place, the control unit 150 commands the display device to display the motion sickness prevention information moving in the direction based on the direction in which the automobile is scheduled to rotate, before the automobile reaches the first place.

The motion sickness prevention information will be described later. Incidentally, the motion sickness prevention information may be referred to as a control stimulus. The timing of starting the display of the motion sickness prevention information may be any time as long as it is before the automobile reaches the first place. For example, the timing of displaying the motion sickness prevention information is timing that is earlier than a scheduled time when the automobile is scheduled to reach the first place by a predetermined time. Alternatively, for example, the timing of displaying the motion sickness prevention information is when the automobile reaches a position at a predetermined distance from the first place. Further, the motion sickness prevention information to be displayed is information generated based on a part of “the route closer to the destination than the position of the mobile object on the route”.

Here, the direction based on the direction in which the automobile is scheduled to rotate will be explained. For example, in a case where the automobile makes a left turn at a future time, the control unit 150 may either display the motion sickness prevention information that moves from right to left or display the motion sickness prevention information that moves from right to left like drawing a curved line. The control unit 150 may also display the motion sickness prevention information that moves from bottom right to top left. In short, the motion sickness prevention information may move in any way as long as it moves from right to left. Incidentally, the direction based on the direction in which the automobile is scheduled to rotate is referred to also as a first direction.

Further, the display device is a projector, a display, a smartphone or the like, for example.

The control unit 150 may make the display device display the motion sickness prevention information moving in the first direction or a direction opposite to the first direction when the automobile reaches the first place. Further, the control unit 150 may make the display device display the motion sickness prevention information moving in the first direction or the opposite direction after the automobile passes through the first place.

The control unit 150 may increase the speed of the movement of the motion sickness prevention information as the automobile approaches the first place. Further, the control unit 150 may make the display device stop the displaying of the motion sickness prevention information after the automobile passes through the first place. The control unit 150 may make the display device stop the displaying of the motion sickness prevention information after the elapse of a predetermined time since the time point of displaying the motion sickness prevention information. Furthermore, the control unit 150 may make the display device stop the displaying of the motion sickness prevention information when the automobile has traveled for a predetermined distance from the position of starting the display of the motion sickness prevention information.

Next, an example of a region where the motion sickness prevention information is displayed will be described below.

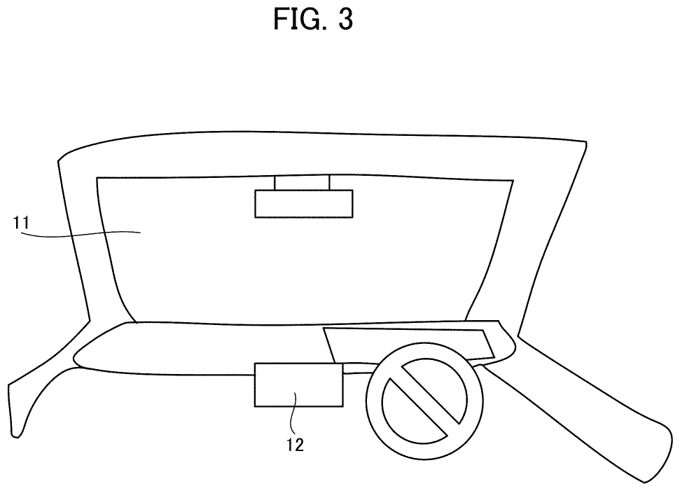

FIG. 3 is a diagram showing an example of the region where the motion sickness prevention information is displayed in the first embodiment. FIG. 3 shows the interior of the automobile. For example, FIG. 3 shows a windshield 11 and a liquid crystal display 12.

The motion sickness prevention information may be displayed anywhere. For example, the projector displays the motion sickness prevention information on the windshield 11. For example, the region where the motion sickness prevention information is displayed is a car navigation system, the instrument panel, an electronic mirror, the liquid crystal display 12, a transmissive display, a window, the ceiling, a pillar, the hood, or the like. Further, the control unit 150 may make the passenger's smartphone display the motion sickness prevention information via a network. Furthermore, instead of the motion sickness prevention information, the direction of the movement of the motion sickness prevention information may be indicated by using Light Emitting Diodes (LEDs).

Next, concrete examples of the motion sickness prevention information will be shown below.

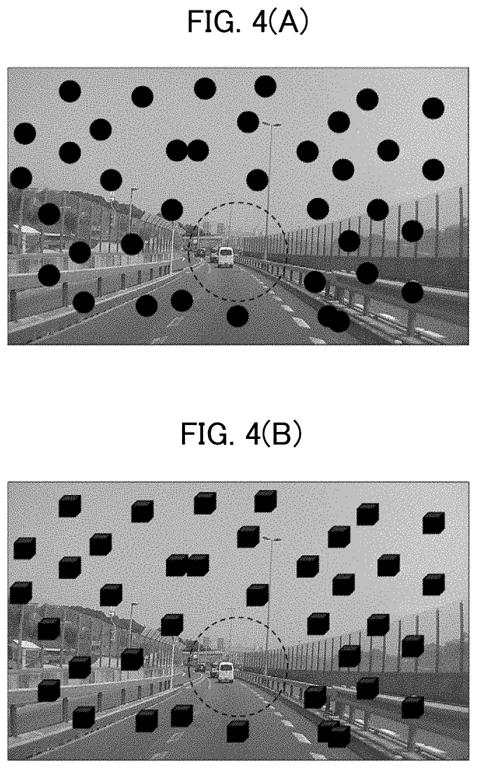

FIGS. 4(A) and 4(B) are diagrams (No. 1) showing concrete examples of the motion sickness prevention information in the first embodiment. FIG. 4(A) shows a state in which the motion sickness prevention information is displayed on the windshield. This motion sickness prevention information is indicated by circles. FIG. 4(B) shows a state in which the motion sickness prevention information is displayed on the windshield. This motion sickness prevention information is indicated by cubes.

As above, the motion sickness prevention information is a two-dimensional or three-dimensional figure. For example, the motion sickness prevention information can be a sphere, a trigonal pyramid, grid-like information, stripe information or the like. The figure may either be a single figure or include a plurality of figures.

Incidentally, the motion sickness prevention information is not displayed at the center of the visual field as shown in FIGS. 4(A) and 4(B).

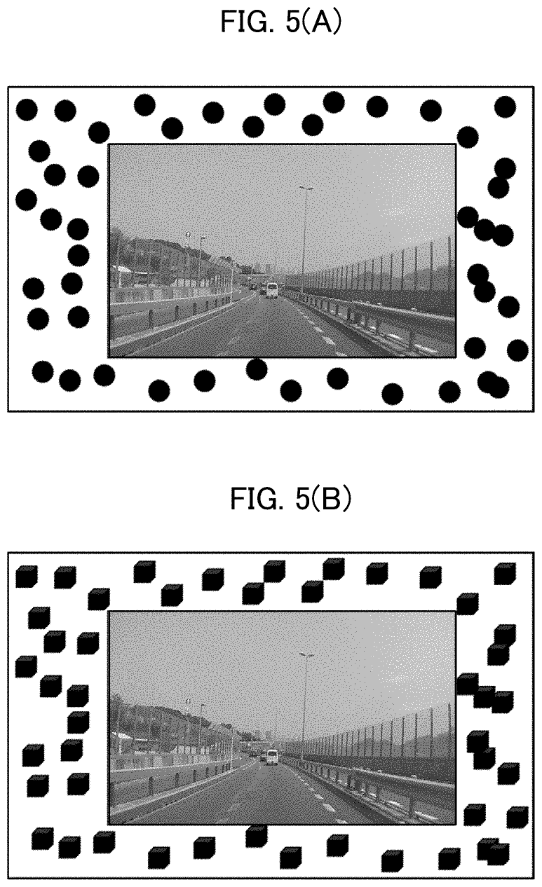

FIGS. 5(A) and 5(B) are diagrams (No. 2) showing concrete examples of the motion sickness prevention information in the first embodiment. FIG. 5(A) shows a state in which the motion sickness prevention information is displayed outside the windshield. FIG. 5(B) shows a state in which the motion sickness prevention information is displayed outside the windshield. As above, the motion sickness prevention information may be displayed outside the windshield.

Further, it is also possible to display at least one of the motion sickness prevention information and the fluid stimulus outside the windshield.

Next, a process executed by the information processing device 100 will be described below by using a flowchart.

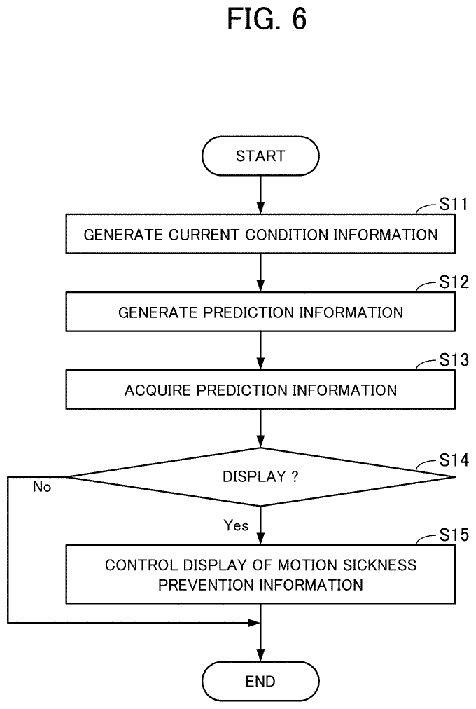

FIG. 6 is a flowchart showing an example of a process executed by the information processing device in the first embodiment. The process of FIG. 6 is executed periodically.

(Step S11) The current condition information generation unit 120 generates current condition information indicating current position information on the information processing device 100 by using the GPS. Namely, the current condition information generation unit 120 generates current condition information indicating current position information on the automobile.

(Step S12) The prediction information generation unit 130 generates prediction information indicating whether or not the automobile including the information processing device 100 is scheduled to rotate at the first place. For example, the prediction information generation unit 130 generates the prediction information based on the position information on the information processing device 100 indicated by the current condition information and the first place included in the route information.

(Step S13) The acquisition unit 140 acquires the prediction information from the prediction information generation unit 130.

(Step S14) The control unit 150 acquires the prediction information from the acquisition unit 140. The control unit 150 judges whether the automobile is scheduled to rotate at the first place or not based on the prediction information. If the automobile is scheduled to rotate at the first place, the control unit 150 determines whether to display the motion sickness prevention information or not based on various threshold values. When the control unit 150 determines to display the motion sickness prevention information, the process advances to step S15. When the motion sickness prevention information is not displayed, the process ends.

(Step S15) The control unit 150 makes the display device display the motion sickness prevention information, moving in the direction based on the direction in which the automobile is scheduled to rotate, before the automobile reaches the first place. For example, in a case where the automobile moves upward at a future time on an uneven road, the control unit 150 makes the display device display the motion sickness prevention information moving from bottom to top. In a case where the automobile moves downward at a future time on an uneven road, the control unit 150 makes the display device display the motion sickness prevention information moving from top to bottom. Further, in a case where the automobile makes a left turn, the control unit 150 makes the display device display the motion sickness prevention information moving from right to left. In a case where the automobile makes a right turn, the control unit 150 makes the display device display the motion sickness prevention information moving from left to right. The following description will be given of the case where the automobile makes a left turn or a right turn.

Further, the information processing device 100 may acquire the result of displaying the motion sickness prevention information. Namely, the result is fed back. Then, the information processing device 100 may adjust the speed of the movement of the motion sickness prevention information based on the result.

Next, the direction of the movement of the motion sickness prevention information will be described concretely below.

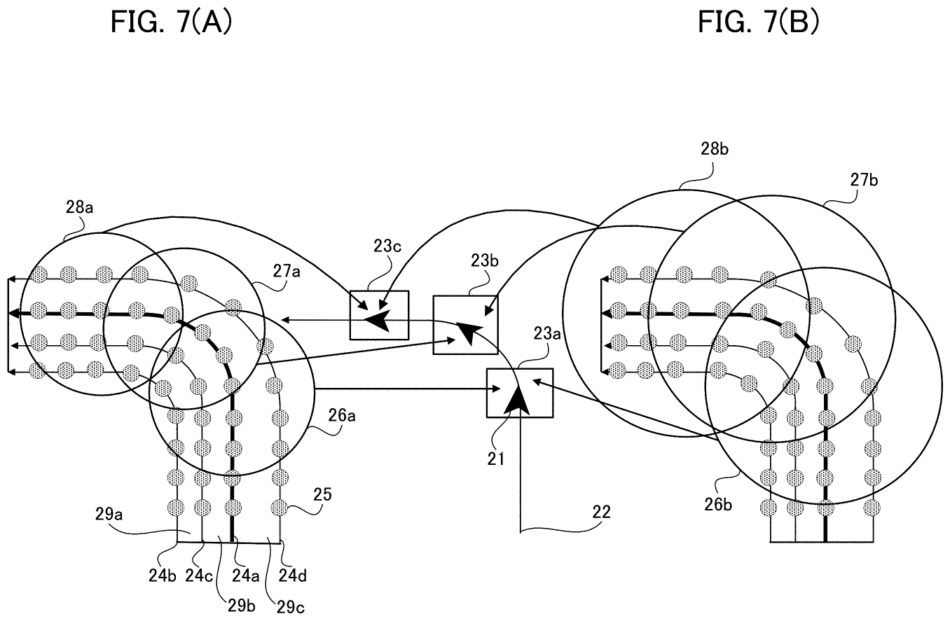

FIG. 7 is a diagram (No. 1) for explaining the direction of the movement of the motion sickness prevention information in the first embodiment. FIG. 7 indicates the automobile 21. An arrow indicating the automobile 21 hereinafter represents the automobile. The direction of the arrow indicates the direction of the automobile. The information processing device 100 is situated in the automobile 21. A route 22 is the route on which the automobile 21 advances. In other words, the route 22 indicates the route information. The automobile 21 is situated at a place 23a.

Paths 24a to 24d are paths of the motion sickness prevention information. The paths of the motion sickness prevention information may be generated by performing affine transformation on a part of the automobile's route closer to the destination than the position of the automobile on the route. The paths of the motion sickness prevention information may be generated based on the route information on the automobile. The path 24a is a reference path of the motion sickness prevention information. A certain piece of the motion sickness prevention information moves on the reference path. The other pieces of the motion sickness prevention information move on loci that keep on maintaining a prescribed positional relationship (e.g., equal distance) with the reference path. It is also possible to generate a plurality of reference paths with respect to the route of the automobile. FIG. 7 shows a case where the route 22 and the path 24a coincide with each other.

In FIG. 7, the motion sickness prevention information moving along a path of the motion sickness prevention information generated by extracting a part of the route of the automobile is displayed. The visual field changes with the movement of the automobile. The speed of the automobile advancing on the route of the automobile and the speed of the motion sickness prevention information advancing on the path of the motion sickness prevention information do not have to be the same as each other. For example, the speed of the motion sickness prevention information can be faster. Accordingly, to the passenger, the movement of the motion sickness prevention information appears to be changing. The display of the motion sickness prevention information will be described concretely below.

FIG. 7(A) shows a case where a range in which the motion sickness prevention information is displayed is narrow. Further, FIG. 7(A) shows the motion sickness prevention information. For example, circles 25 represent the motion sickness prevention information. Circles hereinafter represent the motion sickness prevention information. When the automobile 21 is situated at the place 23a, the motion sickness prevention information in a range 26a is displayed. For example, when the automobile 21 is situated at the place 23a, the motion sickness prevention information included in the visual field, included in the motion sickness prevention information in the range 26a, is displayed on the windshield. When the automobile 21 is situated at the place 23b, the motion sickness prevention information in a range 27a is displayed. When the automobile 21 is situated at the place 23c, the motion sickness prevention information in a range 28a is displayed. The range 26a, the range 27a and the range 28a are display ranges for the explanation that are represented by circles. The display range does not need to be a circle or a sphere but can be in a different shape such as a rectangular prism or a rectangle. In FIG. 7, the center of the circle of each of the range 26a, the range 27a and the range 28a is assumed to be the position of the host automobile for the sake of explanation.

FIG. 7(B) shows a case where the range in which the motion sickness prevention information is displayed is wide. When the automobile 21 is situated at the place 23a, the motion sickness prevention information in a range 26b is displayed. When the automobile 21 is situated at the place 23b, the motion sickness prevention information in a range 27b is displayed. When the automobile 21 is situated at the place 23c, the motion sickness prevention information in a range 28b is displayed.

As above, the control unit 150 makes the display device display the motion sickness prevention information moving in the first direction according to the path of the motion sickness prevention information. Alternatively, the control unit 150 may make the display device display the motion sickness prevention information moving in the opposite direction of the first direction according to the path of the motion sickness prevention information.

Incidentally, ranges 29a, 29b and 29c represent display ranges of the motion sickness prevention information. The display ranges of the motion sickness prevention information will be described later.

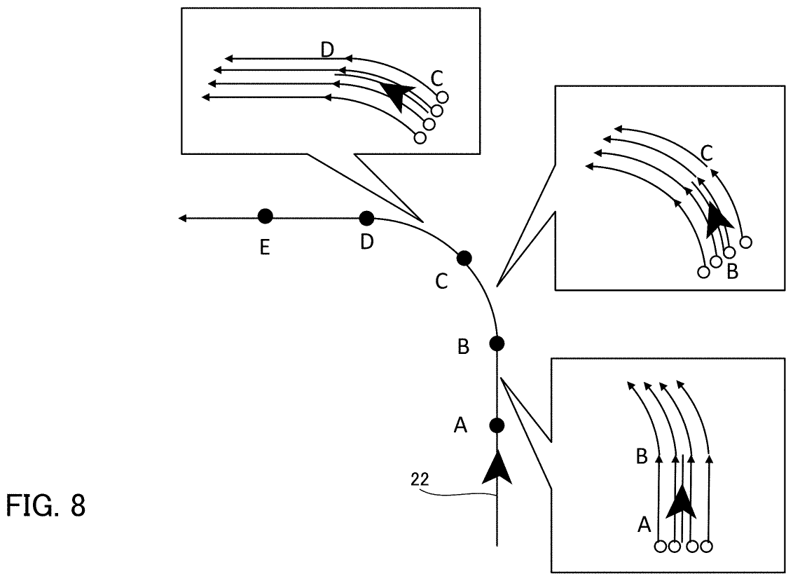

FIG. 8 is a diagram (No. 1) showing a concrete example of the direction of the movement of the motion sickness prevention information in the first embodiment. FIG. 8 indicates that a point A to a point E exist on the route 22. FIG. 8 shows the case of FIG. 7(A) where the range in which the motion sickness prevention information is displayed is narrow and the case of FIG. 7(B) where the range in which the motion sickness prevention information is displayed is wide.

The information processing device 100 is capable of making the display device display the motion sickness prevention information moving in a direction as a combination of a direction in which the automobile is currently moving and a direction in which the automobile advances at a future time.

When the automobile is situated between the point A and the point B, for example, the motion sickness prevention information displayed on the windshield moves from right to left in the middle.

When the automobile is situated between the point B and the point C, for example, the motion sickness prevention information displayed on the windshield moves from right to left.

When the automobile is situated between the point C and the point D, for example, the motion sickness prevention information displayed on the windshield moves from right to left.

Further, the information processing device 100 may also make the display device display the motion sickness prevention information moving in a direction as a combination of the direction in which the automobile is currently moving and a direction opposite to the direction in which the automobile advances at a future time.

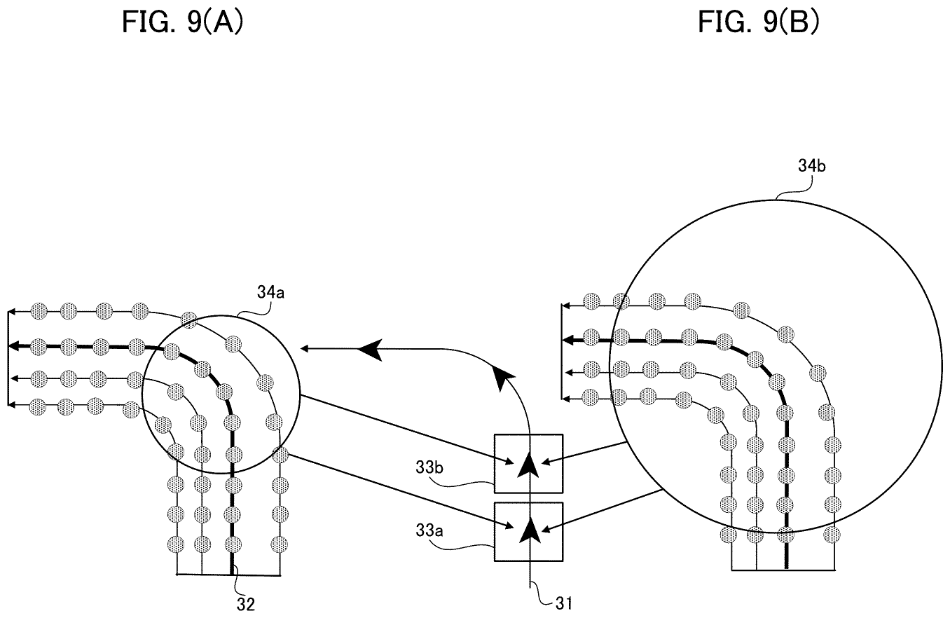

FIG. 9 is a diagram (No. 2) for explaining the direction of the movement of the motion sickness prevention information in the first embodiment. A route 31 is the route on which the automobile advances. A path 32 is the reference path of the motion sickness prevention information. FIG. 9 shows a case where the route 31 and the path 32 coincide with each other.

In FIG. 9, the motion sickness prevention information moving along the path of the motion sickness prevention information generated by extracting a part of the route of the automobile is displayed. Even when the position of the automobile on the route changes, the motion sickness prevention information moving in the same way is displayed. The speed of the automobile advancing on the route of the automobile and the speed of the motion sickness prevention information advancing on the path of the motion sickness prevention information do not have to be the same as each other. For example, the speed of the motion sickness prevention information can be faster. The display of the motion sickness prevention information will be described concretely below.

FIG. 9(A) shows a case where the range in which the motion sickness prevention information is displayed is narrow. When the automobile is situated at a place 33a, the motion sickness prevention information in a range 34a is displayed. When the automobile is situated at a place 33b, the motion sickness prevention information in the range 34a is displayed.

The range 34a is a display range for the explanation that is represented by a circle. The display range does not need to be a circle or a sphere but can be in a different shape such as a rectangular prism or a rectangle. In FIG. 9, the movement of the motion sickness prevention information in the visual field of the host automobile, on the assumption that the host automobile position is at the center of the circle of the range 34a for the sake of explanation, is displayed when the host automobile is situated at the place 33a, 33b.

FIG. 9(B) shows a case where the range in which the motion sickness prevention information is displayed is wide. When the automobile is situated at the place 33a, the motion sickness prevention information in a range 34b is displayed. When the automobile is situated at the place 33b, the motion sickness prevention information in the range 34b is displayed.

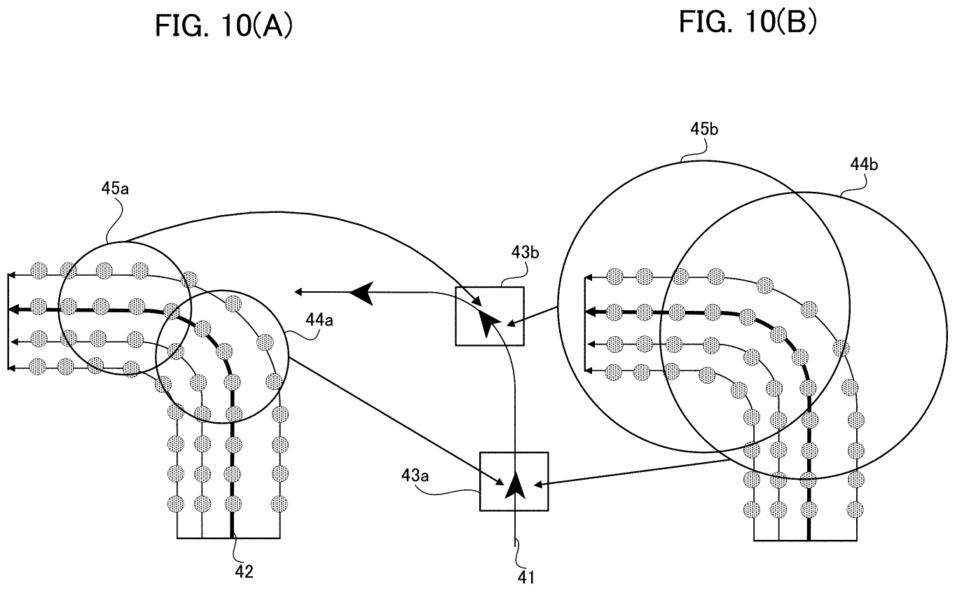

FIG. 10 is a diagram (No. 3) for explaining the direction of the movement of the motion sickness prevention information in the first embodiment. A route 41 is the route on which the automobile advances. A path 42 is the reference path of the motion sickness prevention information. FIG. 10 shows a case where the route 41 and the path 42 coincide with each other.

In FIG. 10, the motion sickness prevention information moving along the path of the motion sickness prevention information generated by extracting a part of the route of the automobile is displayed according to the position of the automobile on the route. The speed of the automobile advancing on the route of the automobile and the speed of the motion sickness prevention information advancing on the path of the motion sickness prevention information do not have to be the same as each other. For example, the speed of the motion sickness prevention information can be faster. The display of the motion sickness prevention information will be described concretely below.

FIG. 10(A) shows a case where the range in which the motion sickness prevention information is displayed is narrow. When the automobile is situated at a place 43a, the motion sickness prevention information in a range 44a is displayed. When the automobile is situated at a place 43b, the motion sickness prevention information in a range 45a is displayed.

The range 44a and the range 45a are display ranges for the explanation that are represented by circles. The display range does not need to be a circle or a sphere but can be in a different shape such as a rectangular prism or a rectangle. In FIG. 10, the movement of the motion sickness prevention information in the visual field of the host automobile, on the assumption that the host automobile position is in the range 44a or the range 45a for the sake of explanation, is displayed when the host automobile is situated at the place 43a or the place 43b.

FIG. 10(B) shows a case where the range in which the motion sickness prevention information is displayed is wide. When the automobile is situated at the place 43a, the motion sickness prevention information in a range 44b is displayed. When the automobile is situated at the place 43b, the motion sickness prevention information in a range 45b is displayed.

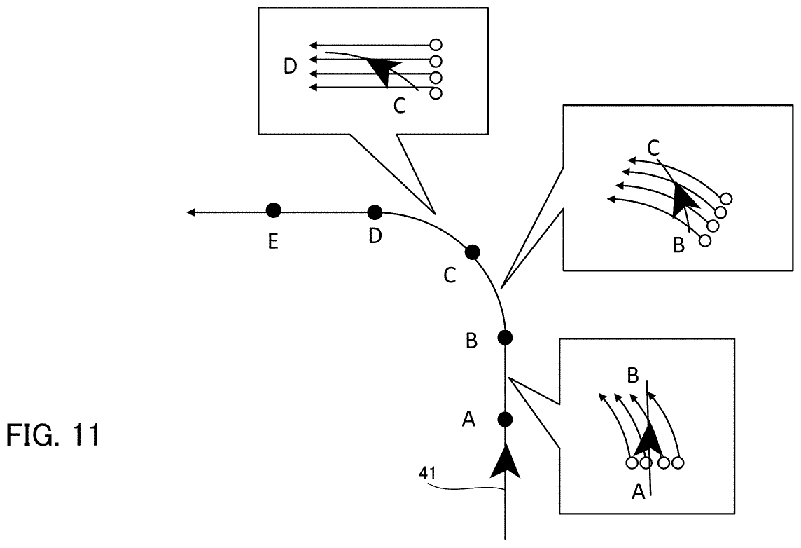

FIG. 11 is a diagram (No. 2) showing a concrete example of the direction of the movement of the motion sickness prevention information in the first embodiment. FIG. 11 indicates that a point A to a point E exist on the route 41.

The place 43a in FIG. 10 may be considered to exist between the point A and the point B. As shown in FIG. 11, when the automobile is situated between the point A and the point B, the automobile is going to rotate leftward (counterclockwise) between the point B and the point C, and thus the information processing device 100 makes the display device display the motion sickness prevention information moving from right to left.

Further, as shown in FIG. 11, when the automobile is situated between the point B and the point C, the automobile is going to rotate leftward (counterclockwise) between the point C and the point D, and thus the information processing device 100 makes the display device display the motion sickness prevention information moving from right to left.

Here, the automobile is assumed to rotate between the point D and the point E. As shown in FIG. 11, when the automobile is situated between the point C and the point D, the automobile is going to rotate between the point D and the point E, and thus the information processing device 100 makes the display device display the motion sickness prevention information moving from right to left.

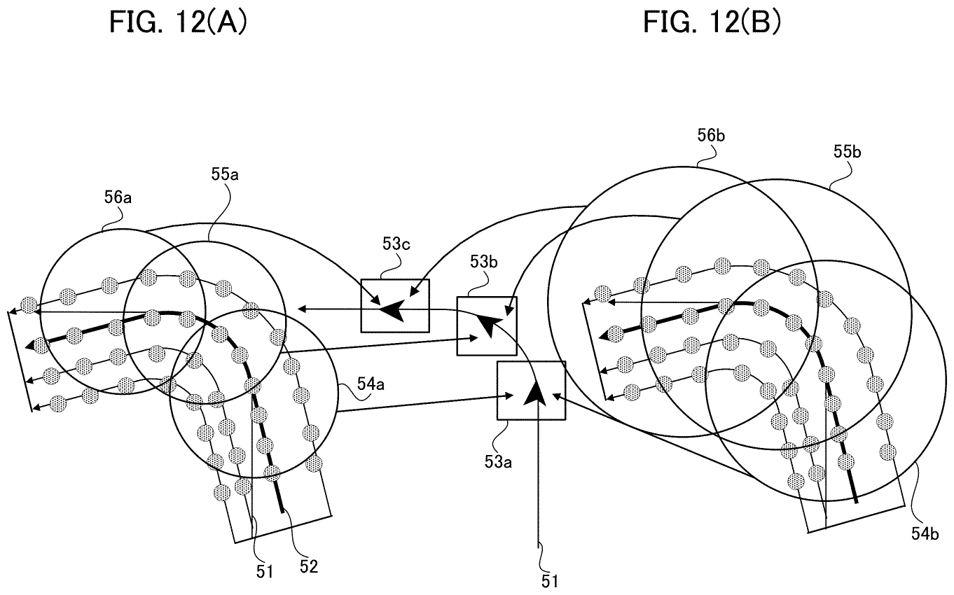

FIG. 12 is a diagram (No. 4) for explaining the direction of the movement of the motion sickness prevention information in the first embodiment. A route 51 is the route on which the automobile advances. A path 52 is the reference path of the motion sickness prevention information. FIG. 12 shows a case where the route 51 and the path 52 do not coincide with each other.

In FIG. 12, the motion sickness prevention information moving along the path of the motion sickness prevention information generated by extracting a part of the route of the automobile is displayed. The visual field changes with the movement of the automobile. Accordingly, to the passenger, the movement of the motion sickness prevention information appears to be changing. The speed of the automobile advancing on the route of the automobile and the speed of the motion sickness prevention information advancing on the path of the motion sickness prevention information do not have to be the same as each other. For example, the speed of the motion sickness prevention information can be faster. The display of the motion sickness prevention information will be described concretely below.

FIG. 12(A) shows a case where the range in which the motion sickness prevention information is displayed is narrow. When the automobile is situated at a place 53a, the motion sickness prevention information in a range 54a is displayed. When the automobile is situated at a place 53b, the motion sickness prevention information in a range 55a is displayed. When the automobile is situated at a place 53c, the motion sickness prevention information in a range 56a is displayed.

The range 54a, the range 55a and the range 56a are display ranges for the explanation that are represented by circles. The display range does not need to be a circle or a sphere but can be in a different shape such as a rectangular prism or a rectangle. In FIG. 12, the center of the circle of each of the range 54a, the range 55a and the range 56a is assumed to be the position of the host automobile for the sake of explanation.

FIG. 12(B) shows a case where the range in which the motion sickness prevention information is displayed is wide. When the automobile is situated at the place 53a, the motion sickness prevention information in a range 54b is displayed. When the automobile is situated at the place 53b, the motion sickness prevention information in a range 55b is displayed. When the automobile is situated at the place 53c, the motion sickness prevention information in a range 56b is displayed.

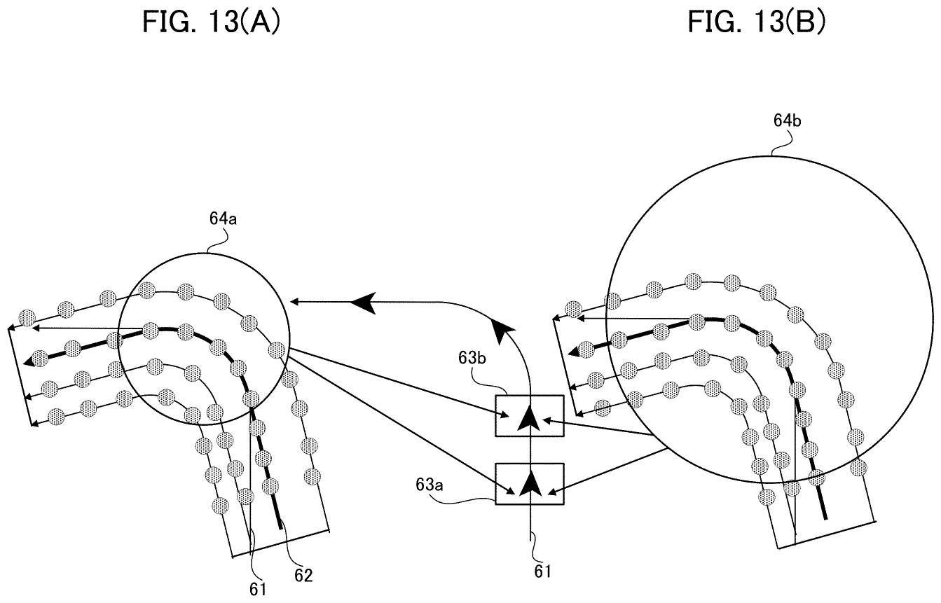

FIG. 13 is a diagram (No. 5) for explaining the direction of the movement of the motion sickness prevention information in the first embodiment. A route 61 is the route on which the automobile advances. A path 62 is the reference path of the motion sickness prevention information. FIG. 13 shows a case where the route 61 and the path 62 do not coincide with each other.

In FIG. 13, the motion sickness prevention information moving along the path of the motion sickness prevention information generated by extracting a part of the route of the automobile is displayed. Even when the position of the automobile on the route changes, the motion sickness prevention information moving in the same way is displayed. The speed of the automobile advancing on the route of the automobile and the speed of the motion sickness prevention information advancing on the path of the motion sickness prevention information do not have to be the same as each other. For example, the speed of the motion sickness prevention information can be faster. The display of the motion sickness prevention information will be described concretely below.

FIG. 13(A) shows a case where the range in which the motion sickness prevention information is displayed is narrow. When the automobile is situated at a place 63a, the motion sickness prevention information in a range 64a is displayed. When the automobile is situated at a place 63b, the motion sickness prevention information in the range 64a is displayed.

The range 64a is a display range for the explanation that is represented by a circle. The display range does not need to be a circle or a sphere but can be in a different shape such as a rectangular prism or a rectangle. In FIG. 13, the movement of the motion sickness prevention information in the visual field of the host automobile, on the assumption that the host automobile position is at the center of the circle of the range 64a for the sake of explanation, is displayed when the host automobile is situated at the place 63a, 63b.

FIG. 13(B) shows a case where the range in which the motion sickness prevention information is displayed is wide. When the automobile is situated at the place 63a, the motion sickness prevention information in a range 64b is displayed. When the automobile is situated at the place 63b, the motion sickness prevention information in the range 64b is displayed.

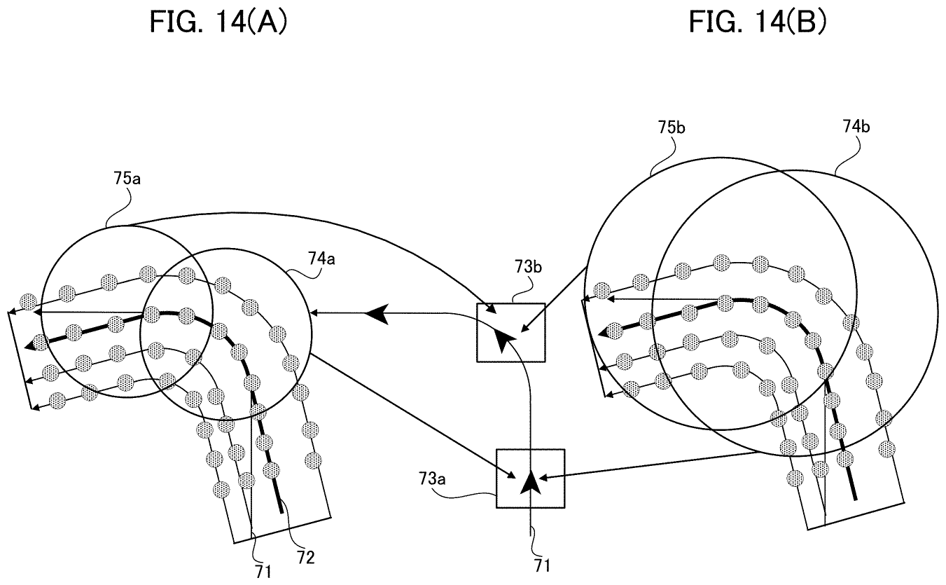

FIG. 14 is a diagram (No. 6) for explaining the direction of the movement of the motion sickness prevention information in the first embodiment. A route 71 is the route on which the automobile advances. A path 72 is the reference path of the motion sickness prevention information. FIG. 14 shows a case where the route 71 and the path 72 do not coincide with each other.

In FIG. 14, the motion sickness prevention information moving along the path of the motion sickness prevention information generated by extracting a part of the route of the automobile is displayed according to the position of the automobile on the route. The speed of the automobile advancing on the route of the automobile and the speed of the motion sickness prevention information advancing on the path of the motion sickness prevention information do not have to be the same as each other. For example, the speed of the motion sickness prevention information can be faster. The display of the motion sickness prevention information will be described concretely below.

FIG. 14(A) shows a case where the range in which the motion sickness prevention information is displayed is narrow. When the automobile is situated at a place 73a, the motion sickness prevention information in a range 74a is displayed. When the automobile is situated at a place 73b, the motion sickness prevention information in a range 75a is displayed.

The range 74a and the range 75a are display ranges for the explanation that are represented by circles. The display range does not need to be a circle or a sphere but can be in a different shape such as a rectangular prism or a rectangle. In FIG. 14, the movement of the motion sickness prevention information in the visual field of the host automobile, on the assumption that the host automobile position is at the center of the circle of the range 74a or the range 75a for the sake of explanation, is displayed when the host automobile is situated at the place 73a or the place 73b.

FIG. 14(B) shows a case where the range in which the motion sickness prevention information is displayed is wide. When the automobile is situated at the place 73a, the motion sickness prevention information in a range 74b is displayed. When the automobile is situated at the place 73b, the motion sickness prevention information in a range 75b is displayed.

A display range in a direction orthogonal to the movement of the motion sickness prevention information is a range formed by providing the path of the motion sickness prevention information or the route of the host automobile, as one reference, with a width for a predetermined distance in a transverse direction orthogonal to the traveling direction. Next, a description will be given of an example in which the display range of the motion sickness prevention information is displayed only in one of the leftward direction and the rightward direction with respect to the route of the host automobile or a median line of the host automobile.

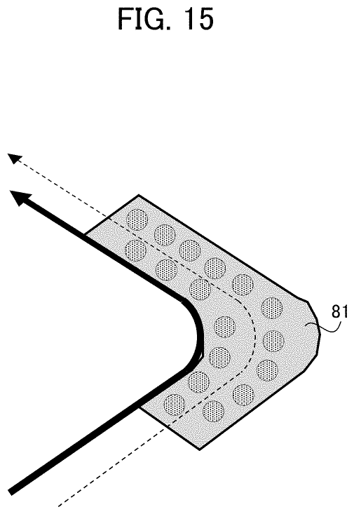

FIG. 15 is a diagram (No. 1) for explaining the display range of the motion sickness prevention information. A display range 81 is the display range of the motion sickness prevention information.

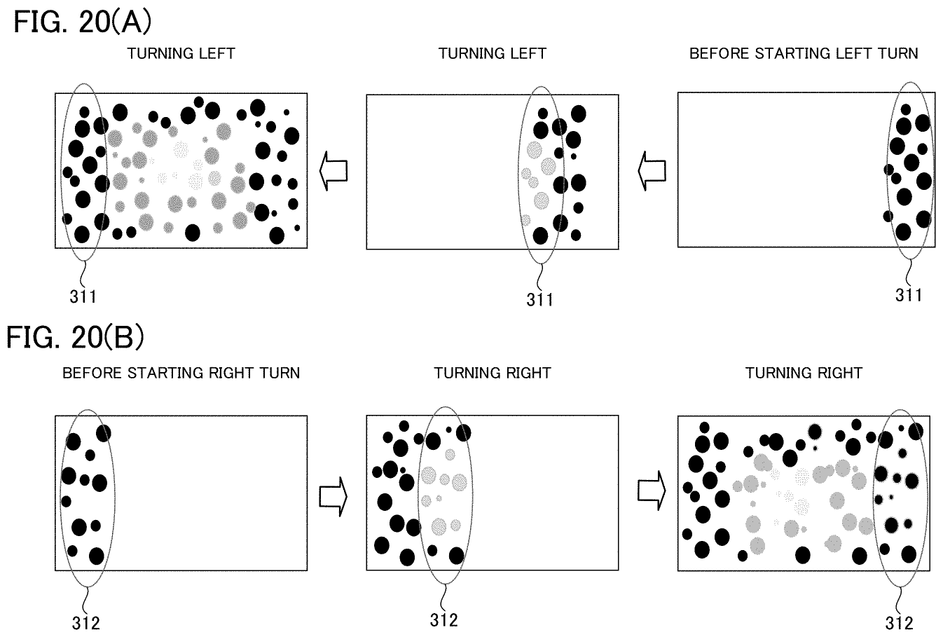

When the route of the automobile and the reference path of the motion sickness prevention information differs from each other and the automobile makes a left turn, the motion sickness prevention information is displayed on the right side of the route of the automobile. Here, in a case where the motion sickness prevention information moves at higher speed than the automobile, the display range of the motion sickness prevention information enlarges leftward from the right as shown in FIG. 20 which will be explained later. Similarly, when the automobile makes a right turn, the display range of the motion sickness prevention information enlarges rightward from the left.

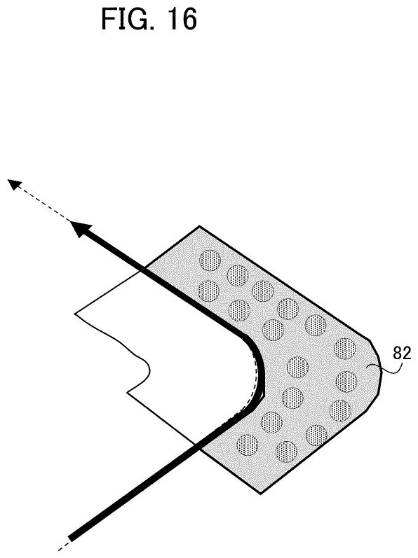

FIG. 16 is a diagram (No. 2) for explaining the display range of the motion sickness prevention information. A display range 82 is the display range of the motion sickness prevention information.

It shows a case where the route of the automobile and the reference path of the motion sickness prevention information coincide with each other. At the time of making a left turn, the motion sickness prevention information may be displayed only in a range formed by providing the reference path of the motion sickness prevention information as one reference with a width in a rightward direction. Further, at the time of making a left turn, the motion sickness prevention information may be displayed only on the right side of the automobile.

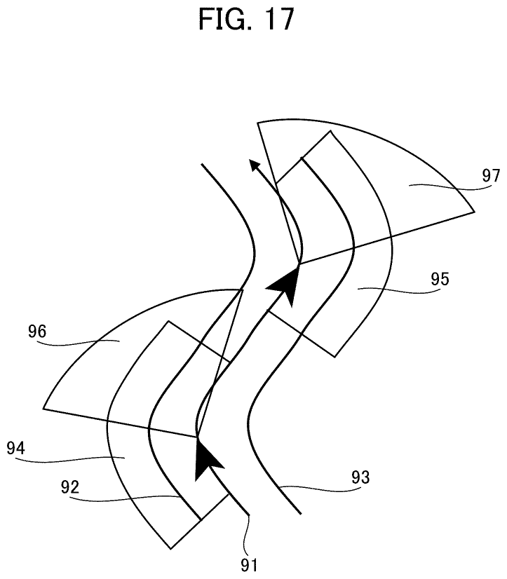

FIG. 17 is a diagram showing a concrete example of the direction of the movement of the motion sickness prevention information when the automobile makes a right turn and a left turn in the first embodiment.

A route 91 is the route on which the automobile advances. Paths 92 and 93 are the reference paths of the motion sickness prevention information. Display ranges 94 and 95 are the ranges in which the motion sickness prevention information is displayed. For example, when the automobile has passed through the display range 94, the information processing device 100 makes the display device stop the displaying of the motion sickness prevention information in the display range 94.

Regions 96 and 97 indicate the visual field of the passenger. When the automobile makes a right turn, for example, the passenger views the motion sickness prevention information moving from left to right. When the automobile makes a left turn, for example, the passenger views the motion sickness prevention information moving from right to left.

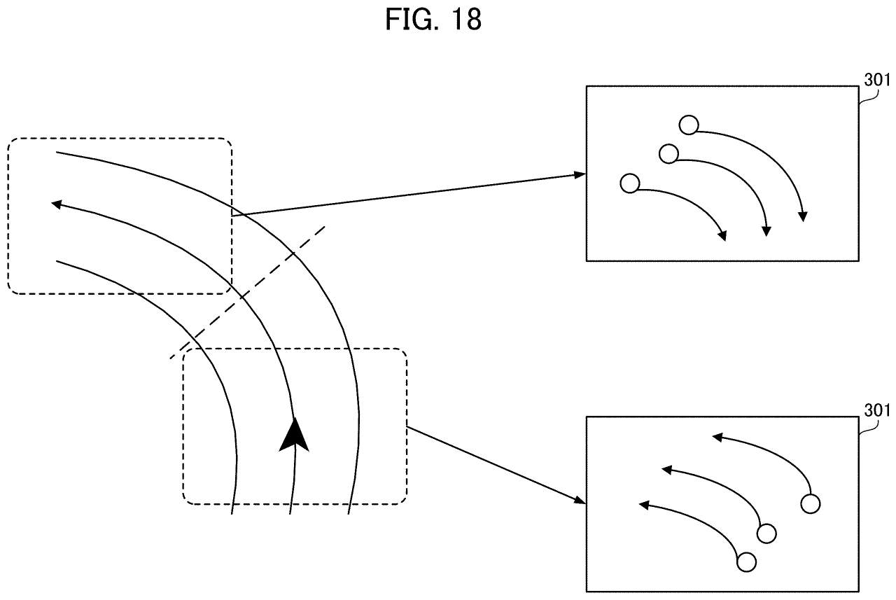

FIG. 18 is a diagram (No. 3) showing a concrete example of the direction of the movement of the motion sickness prevention information in the first embodiment. The motion sickness prevention information has been described to move in a direction in which the automobile advances at a future time. However, the information processing device 100 may also make the display device display the motion sickness prevention information moving in the direction opposite to the direction in which the automobile advances at a future time.

For example, the acquisition unit 140 acquires prediction information indicating that the automobile makes a left turn at a future time and the automobile decelerates from the prediction information generation unit 130. The control unit 150 moves the motion sickness prevention information in the direction in which the automobile advances at the future time based on the prediction information. FIG. 18 indicates that the motion sickness prevention information moving in the direction in which the automobile advances at the future time is displayed on a windshield 301.

Further, for example, the acquisition unit 140 acquires prediction information indicating that the automobile makes a left turn at a future time and the automobile accelerates from the prediction information generation unit 130. Based on the prediction information, the control unit 150 judges that the automobile rotates at the future time. The control unit 150 makes the display device display the motion sickness prevention information moving in the direction opposite to the direction in which the automobile advances at the future time. FIG. 18 indicates that the motion sickness prevention information moving in the direction opposite to the direction in which the automobile advances at the future time is displayed on the windshield 301. As above, the information processing device 100 may make the display device display the motion sickness prevention information moving in the direction opposite to the first direction.

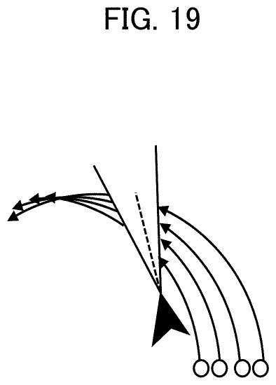

FIG. 19 is a diagram (No. 1) for explaining the display in a central visual field in the first embodiment. When the motion sickness prevention information passes through the central visual field of the passenger, the control unit 150 controls the display device so as not to display the motion sickness prevention information in the central visual field of the passenger situated in the automobile.

FIGS. 20(A) and 20(B) are diagrams (No. 2) for explaining the display in the central visual field in the first embodiment. FIG. 20(A) indicates that the motion sickness prevention information moving from right to left is displayed on the windshield. Motion sickness prevention information in a small shape is situated far away. As above, the motion sickness prevention information may be displayed in three dimensions.

The motion sickness prevention information in a frame 311 moves from right to left. Further, the amount of the motion sickness prevention information increases gradually. As in this example, the control unit 150 may control the display device so as to increase the amount of the motion sickness prevention information in the first direction or in the direction opposite to the first direction. Here, the information processing device 100 may also control the display device so as to increase the transmittance of the motion sickness prevention information as the motion sickness prevention information is closer to the central visual field of the passenger. Incidentally, the information processing device 100 is capable of acquiring information indicating the central visual field of the passenger from the driver monitoring system.

FIG. 20(B) indicates that the motion sickness prevention information moving from left to right is displayed on the windshield. The motion sickness prevention information in a frame 312 moves from left to right. Similarly, the information processing device 100 may also control the display device so as to increase the transmittance of the motion sickness prevention information as the motion sickness prevention information is closer to the central visual field of the passenger.

Incidentally, FIGS. 20(A) and 20(B) are just examples for illustration.

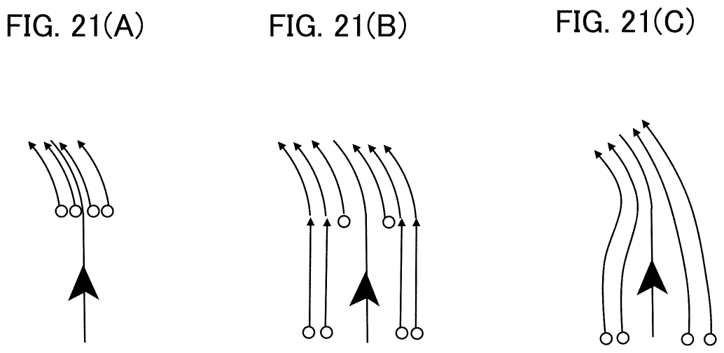

FIGS. 21(A) to 21(C) are diagrams showing concrete examples regarding a method for not displaying the motion sickness prevention information in the vicinity of the automobile in the first embodiment in order to eliminate the sense of collision. FIGS. 21(A) to 21(C) indicate cases where the motion sickness prevention information is displayed as three-dimensional information. FIGS. 21(A) to 21(C) indicate the directions of the movement of the motion sickness prevention information as viewed from above.

FIG. 21(A) shows a case where the motion sickness prevention information is displayed only in front. Thus, it appears to the passenger that motion sickness prevention information in a small shape exists far away as shown in FIG. 20. As in this example, the information processing device 100 may display the motion sickness prevention information in front.

FIG. 21(B) shows a case where the motion sickness prevention information is not displayed within a certain distance from the automobile. As in this example, the information processing device 100 may display parts of the motion sickness prevention information in front, in a transverse direction, etc.

FIG. 21(C) shows a case where the motion sickness prevention information is displayed so as to avoid the automobile. As in this example, the information processing device 100 may control the display device so that the motion sickness prevention information moves while avoiding the automobile.

As above, the control unit 150 controls the display device so as not to display the motion sickness prevention information within a predetermined distance from the automobile.

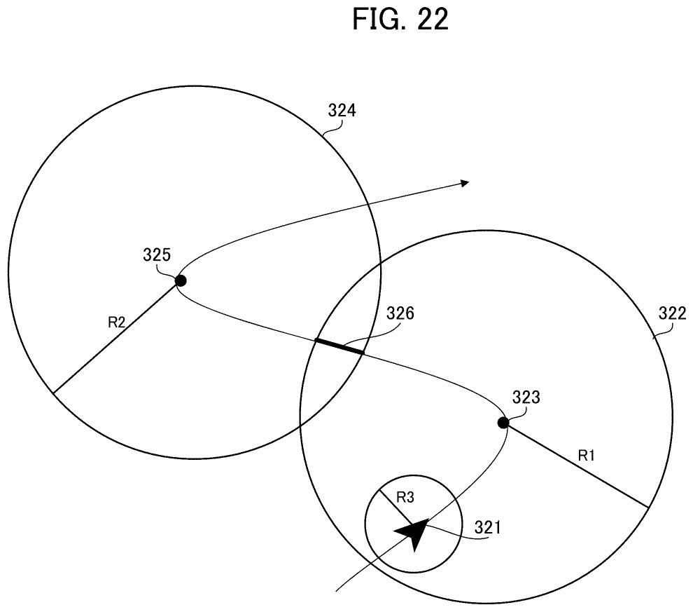

FIG. 22 is a diagram for explaining the display of the motion sickness prevention information in the first embodiment. The information processing device 100 may make the display device display the motion sickness prevention information by the following method:

FIG. 22 indicates an automobile 321. A range 322 represents the first place. A point 323 indicates the position of a corner situated at the first place. In other words, the point 323 indicates the position of the corner situated at the first place and indicates the center of the range 322. The radius of the range 322 is R1.

A range 324 represents a second place. The second place is a place that is closer to the destination of the automobile 321 than the point 323 indicating the corner situated at the first place. A point 325 indicates the position of a corner situated at the second place. In other words, the point 325 indicates the position of the corner situated at the second place and indicates the center of the range 324. The radius of the range 324 is R2.

FIG. 22 indicates that the motion sickness prevention information is not displayed in the vicinity of the automobile 321 as explained with reference to FIG. 21. Incidentally, the radius of the range in which the motion sickness prevention information is not displayed is R3.

R1, R2 and R3 may be all different lengths or all the same length. Alternatively, two of R1, R2 and R3 may be the same length. Incidentally, each of the range 322 and the range 324 does not necessarily have to be a circle but can be a range obtained from a straight line distance or a route length from the corner based on the time it takes to reach the position of the corner. Further, the distance until reaching the corner and the distance after reaching the corner do not have to be equal to each other.

The prediction information generation unit 130 generates the prediction information. The prediction information indicates whether or not the automobile 321 is scheduled to rotate at the second place which is closer to the destination of the automobile 321 than the point 323 indicating the corner situated at the first place.

The acquisition unit 140 acquires the prediction information. When the prediction information indicates that the automobile 321 is scheduled to rotate at the second place, a part of the range 322 representing the first place overlaps with the range 324 representing the second place, and the automobile 321 is situated in the overlapping range, the control unit 150 makes the display device display the motion sickness prevention information moving in a second direction based on a direction in which the automobile 321 is scheduled to rotate at the second place.

As above, when the automobile 321 is situated in a place 326, the information processing device 100 makes the display device display the motion sickness prevention information moving in the second direction.

Further, the control unit 150 may control the speed of the motion sickness prevention information. For example, when the motion sickness prevention information moves from left to right, the control unit 150 may control the display device so as to slow down the movement of the motion sickness prevention information as the motion sickness prevention information approaches a right edge. The control unit 150 may also use a current automobile speed or a relative speed with respect to a future automobile speed as the speed of the motion sickness prevention information and control the display device so as to speed up the movement of the motion sickness prevention information with the increase in the automobile speed. The control unit 150 may also perform the control so as to adjust the speed depending on the distance from the corner in the straight line distance or the route length from the center of the corner.

Furthermore, the control unit 150 may control the density (e.g., chromaticity, luminance, brightness, or contrast with the fluid stimulus) of the motion sickness prevention information. For example, when the motion sickness prevention information moves from left to right, the control unit 150 may control the display device so as to thin the color of the motion sickness prevention information as the motion sickness prevention information approaches the right edge.

Moreover, the control unit 150 may control the size of the motion sickness prevention information. For example, when the motion sickness prevention information moves from left to right, the control unit 150 may control the display device so as to reduce the size of the motion sickness prevention information as the motion sickness prevention information approaches the right edge.

In addition, the control unit 150 may control the transmittance of the motion sickness prevention information. For example, when the motion sickness prevention information moves from left to right, the control unit 150 may control the display device so as to increase the transmittance of the motion sickness prevention information as the motion sickness prevention information approaches the right edge.

According to the first embodiment, the information processing device 100 makes the display device display the motion sickness prevention information having both meanings of the speed sense adjustment and the prediction information. Further, the information processing device 100 does not display the arrow indicating the traveling direction. Thus, the information processing device 100 mitigates the obstruction of the visual field. Accordingly, the information processing device 100 is capable of increasing the comfortability.

Further, the control unit 150 may make the display device display the motion sickness prevention information while changing the display distance of the motion sickness prevention information. For example, the control unit 150 has the motion sickness prevention information displayed on a transmissive display while adjusting the display distance of the motion sickness prevention information as if the motion sickness prevention information existed at a designated position in the scenery viewed through the transmissive display. The control unit 150 may also make the display device display two-dimensional motion sickness prevention information. Further, the control unit 150 may transform three-dimensional motion sickness prevention information to be displayed to two-dimensional motion sickness prevention information and make the display device display the two-dimensional motion sickness prevention information obtained by the transformation. Here, the display device is a pillar, the screen of the car navigation system, a transmissive display or the like, for example.

### Second Embodiment

Next, a second embodiment will be described below. In the second embodiment, the description will be given mainly of features different from those in the first embodiment. The description is omitted for features in common with the first embodiment. FIGS. 1 to 22 are referred to in the second embodiment.

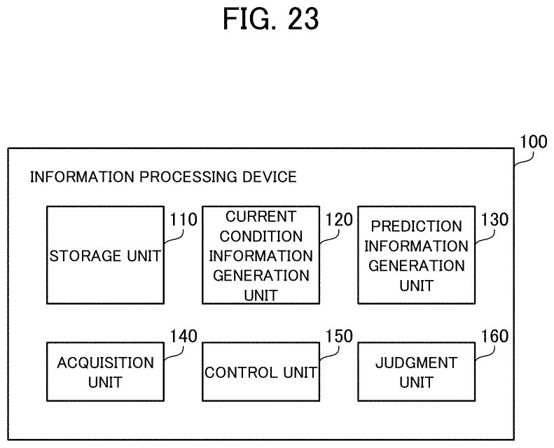

FIG. 23 is a block diagram showing function of an information processing device in the second embodiment. Each component in FIG. 23 being the same as a component shown in FIG. 1 is assigned the same reference character as in FIG. 1. The information processing device 100 further includes a judgment unit 160.

The judgment unit 160 judges a current motion sickness level of the passenger or a future motion sickness level of the passenger. The control unit 150 determines whether to display the motion sickness prevention information or not by using the current motion sickness level of the passenger or the future motion sickness level of the passenger.

First, a case of using the current motion sickness level will be described below.

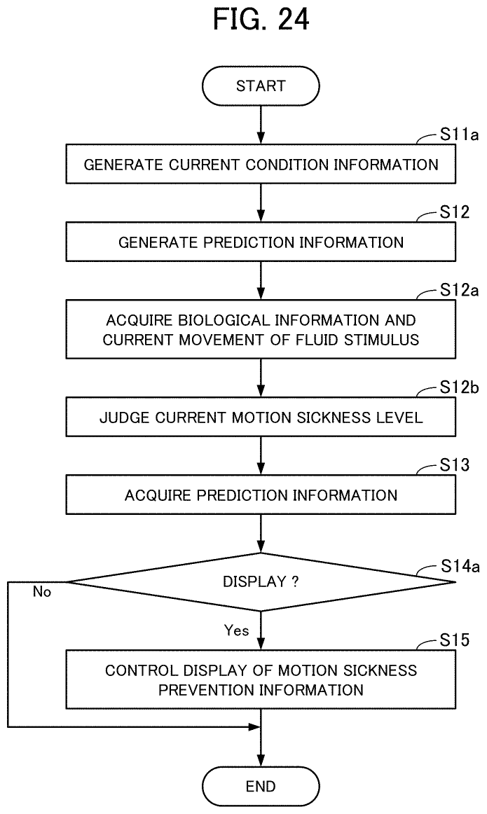

FIG. 24 is a flowchart showing an example of a judgment process using the current motion sickness level in the second embodiment. The process of FIG. 24 differs from the process of FIG. 6 in that steps S11a, S12a, S12b and S14a are executed. Thus, the steps S11a, S12a, S12b and S14a will be described below with reference to FIG. 24. In regard to the other steps in FIG. 24, the description of the processing is left out by assigning them the same step numbers as in FIG. 6.

(Step S11a) The current condition information generation unit 120 generates current condition information indicating current position information on the information processing device 100 by using the GPS. Namely, the current condition information generation unit 120 generates current condition information indicating current position information on the automobile.

Further, the current condition information generation unit 120 generates information indicating current movement of the fluid stimulus. In other words, the current condition information generation unit 120 generates information indicating the current flow of the scenery. For example, the current condition information generation unit 120 generates the information indicating the current movement of the fluid stimulus based on information acquired from the vehicle-outside camera. Incidentally, the information indicating the current movement of the fluid stimulus is information indicating the direction opposite to the direction in which the automobile is currently moving. Furthermore, the current condition information generation unit 120 may generate information including information indicating past movement of the fluid stimulus and the information indicating the current movement of the fluid stimulus.

The current condition information includes the information indicating the current movement of the fluid stimulus.

(Step S12a) The current condition information generation unit 120 acquires biological information on the passenger via a biological information acquisition device. For example, the biological information is brain waves, nictation, heartbeat, expiration, body temperature, barycenter vacillation, perspiration, skin conductance, or the like. The biological information can include information indicating characteristics of the individual such as age, sex, a physical constitution or experiences of the motion sickness. The biological information acquisition device can be a device of the non-contact type or a device of the contact type. For example, the device of the non-contact type is a driver monitoring system. The device of the contact type is the seat, the steering wheel or the like.

The current condition information generation unit 120 may acquire information including past biological information and current biological information. Further, the current condition information generation unit 120 may analyze the biological information.

The acquisition unit 140 acquires the biological information and the information indicating the current movement of the fluid stimulus from the current condition information generation unit 120. The acquisition unit 140 may also acquire the result of the analysis of the biological information from the current condition information generation unit 120.

(Step 12b) The judgment unit 160 judges the current motion sickness level based on the biological information and the information indicating the current movement of the fluid stimulus. When judging the current motion sickness level, the judgment unit 160 may judge the current motion sickness level by using judgment information as information for judging the current motion sickness level. Incidentally, the judgment information is, for example, learning data obtained by machine learning. The judgment unit 160 may also judge the current motion sickness level by means of machine learning. By use of the machine learning, the accuracy of the motion sickness level calculation can be increased.

Here, it is also possible to execute the steps 12a and 12b before the steps S11a and S12 or in parallel with the steps S11a and S12. It is also possible to execute the step S13 before the steps S12a and S12b.

(Step S14a) The control unit 150 acquires the prediction information from the acquisition unit 140.

The control unit 150 judges whether or not the prediction information indicates that the automobile is scheduled to rotate at the first place and the current motion sickness level is higher than or equal to a predetermined threshold value.

If the conditions in the step S14a are satisfied, the control unit 150 determines to display the motion sickness prevention information. Namely, if the prediction information indicates that the automobile is scheduled to rotate at the first place and the current motion sickness level is higher than or equal to the threshold value, the control unit 150 determines to display the motion sickness prevention information. Then, the process advances to the step S15.

If the conditions in the step S14a are not satisfied, the process ends.

Incidentally, the motion sickness level calculation, the threshold value calculation and the display propriety judgment may also be executed at once. Namely, the display propriety may be judged by executing the processes of the step S12b and the step S14a at once by use of machine learning or the like. By use of the machine learning, the accuracy of the motion sickness level calculation can be increased.

In the case where the prediction information indicates that the automobile is scheduled to rotate at the first place and the current motion sickness level is higher than or equal to the threshold value, the control unit 150 may also determine whether to display the motion sickness prevention information or not based on various threshold values. When the motion sickness prevention information is determined to be displayed, the process advances to the step S15. When the motion sickness prevention information is not displayed, the process ends.

As above, the information processing device 100 makes the display device display the motion sickness prevention information when the passenger is suffering from the motion sickness. In conclusion, the information processing device 100 is capable of preventing the passenger from worsening the condition of the motion sickness.

Further, after displaying the motion sickness prevention information, the information processing device 100 may stop the displaying of the motion sickness prevention information when the current motion sickness level falls below the threshold value.

Next, a case of using the future motion sickness level will be described below.

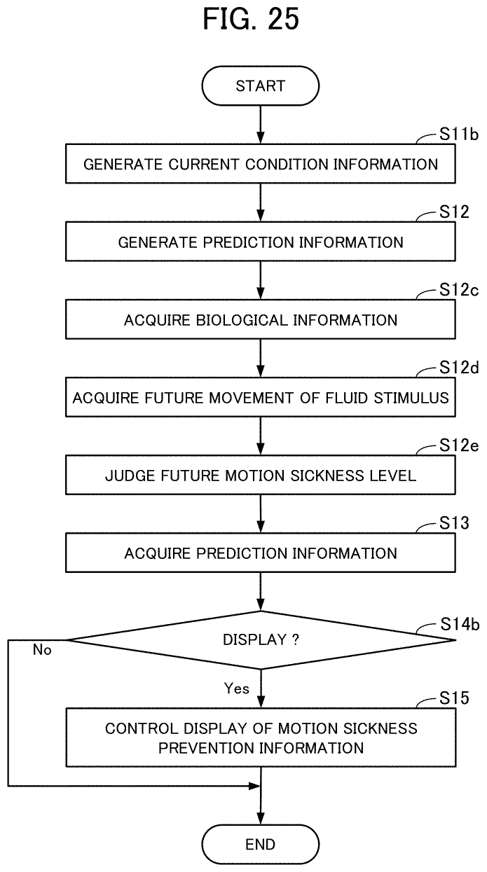

FIG. 25 is a flowchart showing an example of a judgment process using the future motion sickness level in the second embodiment. The process of FIG. 25 differs from the process of FIG. 6 in that steps S11b, S12c, S12d, S12e and S14b are executed. Thus, the steps S11b, S12c, S12d, S12e and S14b will be described below with reference to FIG. 25. In regard to the other steps in FIG. 25, the description of the processing is left out by assigning them the same step numbers as in FIG. 6.

(Step S11b) The current condition information generation unit 120 generates current condition information indicating current position information on the information processing device 100 by using the GPS. Namely, the current condition information generation unit 120 generates current condition information indicating current position information on the automobile.

Further, the current condition information generation unit 120 generates information indicating current movement of the fluid stimulus. In other words, the current condition information generation unit 120 generates information indicating the current flow of the scenery. For example, the current condition information generation unit 120 generates the information indicating the current movement of the fluid stimulus based on information acquired from the vehicle-outside camera. Incidentally, the information indicating the current movement of the fluid stimulus is information indicating the direction opposite to the direction in which the automobile is currently moving. Furthermore, the current condition information generation unit 120 may generate information including information indicating past movement of the fluid stimulus and the information indicating the current movement of the fluid stimulus.

The current condition information includes the information indicating the current movement of the fluid stimulus.

(Step S12c) The current condition information generation unit 120 acquires the biological information on the passenger via the biological information acquisition device. The method of the acquisition is as described earlier. Further, the current condition information generation unit 120 may analyze the biological information.

The acquisition unit 140 acquires the biological information from the current condition information generation unit 120. The acquisition unit 140 may also acquire the result of the analysis of the biological information from the current condition information generation unit 120.

(Step S12d) The prediction information generation unit 130 generates information indicating future movement of the fluid stimulus. For example, the prediction information generation unit 130 generates the information indicating the future movement of the fluid stimulus based on the route information. Incidentally, this information is information indicating a direction opposite to a direction in which the automobile is scheduled to move at the first place.

The acquisition unit 140 acquires the information indicating the future movement of the fluid stimulus from the prediction information generation unit 130.

(Step S12e) The judgment unit 160 judges the future motion sickness level based on the biological information and the information indicating the future movement of the fluid stimulus. When judging the future motion sickness level, the judgment unit 160 may judge the future motion sickness level by using judgment information as information for judging the future motion sickness level. Incidentally, the judgment information is, for example, learning data obtained by machine learning. The judgment unit 160 may also judge the future motion sickness level by means of machine learning. By use of the machine learning, the accuracy of the motion sickness level calculation can be increased.

Here, it is also possible to execute the steps 12c, 12d and 12e before the steps S11b and S12 or in parallel with the steps S11b and S12.

(Step S14b) The control unit 150 acquires the prediction information from the acquisition unit 140. The control unit 150 judges whether or not the prediction information indicates that the automobile is scheduled to rotate at the first place and the future motion sickness level is higher than or equal to a predetermined threshold value.

If the conditions in the step S14b are satisfied, the control unit 150 determines to display the motion sickness prevention information. Namely, if the prediction information indicates that the automobile is scheduled to rotate at the first place and the future motion sickness level is higher than or equal to the threshold value, the control unit 150 determines to display the motion sickness prevention information. Then, the process advances to the step S15.

If the conditions in the step S14b are not satisfied, the process ends.

Incidentally, the motion sickness level calculation, the threshold value calculation and the display propriety judgment may also be executed at once. Namely, the display propriety may be judged by executing the processes of the step S12e and the step S14b at once by use of machine learning or the like. By use of the machine learning, the accuracy of the motion sickness level calculation can be increased.

In the case where the prediction information indicates that the automobile is scheduled to rotate at the first place and the future motion sickness level is higher than or equal to the threshold value, the control unit 150 may also determine whether to display the motion sickness prevention information or not based on various threshold values. When the motion sickness prevention information is determined to be displayed, the process advances to the step S15. When the motion sickness prevention information is not displayed, the process ends.

As above, the information processing device 100 makes the display device display the motion sickness prevention information before the passenger suffers from the motion sickness. In conclusion, the information processing device 100 is capable of preventing the passenger from suffering from the motion sickness.

### Third Embodiment

Next, a third embodiment will be described below. In the third embodiment, the description will be given mainly of features different from those in the first embodiment. The description is omitted for features in common with the first embodiment. FIGS. 1 to 2² are referred to in the third embodiment.

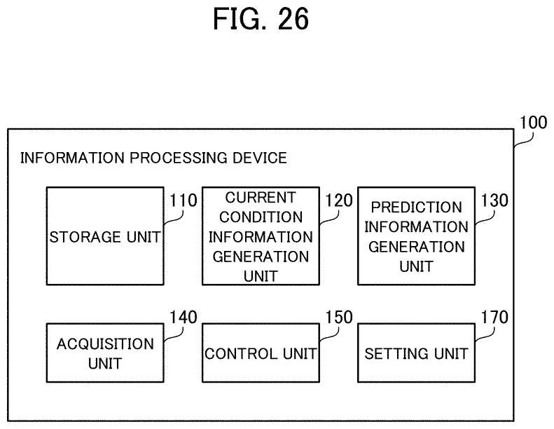

FIG. 26 is a block diagram showing function of an information processing device in the third embodiment. Each component in FIG. 26 being the same as a component shown in FIG. 1 is assigned the same reference character as in FIG. 1. The information processing device 100 further includes a setting unit 170.

The setting unit 170 sets the display region of the motion sickness prevention information. The control unit 150 controls the display device so as to display the motion sickness prevention information in the display region. The third embodiment will be described concretely below.

For example, the setting unit 170 sets a part of the visual field of the passenger as the display region of the motion sickness prevention information. Incidentally, the setting unit 170 acquires information indicating the center of the passenger's visual field from the driver monitoring system, for example. With this information, the setting unit 170 can identify the center of the passenger's visual field.

Further, for example, the setting unit 170 sets a plurality of regions as the display regions of the motion sickness prevention information. For example, the setting unit 170 sets a pillar and the windshield as the display regions of the motion sickness prevention information.

Further, for example, the setting unit 170 acquires information indicating the passenger's visual field range from the driver monitoring system. When the automobile makes a left turn at a future time, the setting unit 170 sets a region in the visual field range corresponding to the rightward direction as the display region of the motion sickness prevention information. For example, this region is a right window. Alternatively, when the automobile makes a left turn, the setting unit 170 sets a region in the visual field range corresponding to the leftward direction as the display region of the motion sickness prevention information. For example, this region is a left window. The display region may be reversed in terms of left and right.

Furthermore, for example, the setting unit 170 sets a region in the visual field range of a particular passenger as the display region of the motion sickness prevention information. Here, the motion sickness is more likely to happen to a person not being the driver than to the driver. Thus, the setting unit 170 sets a region in the visual field range of a person not being the driver as the display region of the motion sickness prevention information. The particular passenger can be a person who is likely to suffer from the motion sickness.

Incidentally, the timing for the setting unit 170 to set the display region of the motion sickness prevention information can be any time as long as it is before the control unit 150 has the motion sickness prevention information displayed.

The control unit 150 may execute the following process:

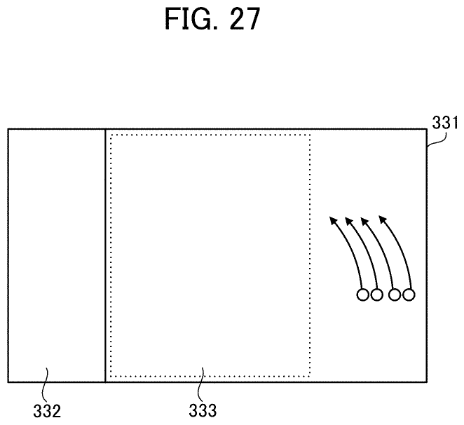

FIG. 27 is a diagram showing a concrete example of the display of the motion sickness prevention information in the third embodiment. FIG. 27 shows a windshield 331. A range 332 is a range that has not been set as the display region by the setting unit 170. Thus, a range on the windshield 331 other than the range 332 is the display region of the motion sickness prevention information.

The control unit 150 may also make the display device display the motion sickness prevention information in a part of the display region. For example, the control unit 150 makes the display device display the motion sickness prevention information in a range in the display region other than a range 333. This prevents the motion sickness prevention information from obstructing the visual field when the automobile makes a left turn, for example. As above, the information processing device 100 is capable of preventing the motion sickness prevention information from obstructing the visual field by displaying the motion sickness prevention information in a part of the display region.

According to the third embodiment, the information processing device 100 is capable of setting the display region of the motion sickness prevention information.

The first to third embodiments may be combined together. The description of the first to third embodiments has been given of cases where the information processing device 100 is situated in an automobile. The first to third embodiments are applicable to cases where the information processing device 100 is situated in a ship, an airplane, a roller coaster, a train, a merry-go-round or the like.

### Fourth Embodiment

Next, a fourth embodiment will be described below. In the fourth embodiment, the description will be given of a case where the motion sickness prevention information is displayed by a simulation device, a device implementing Virtual Reality (VR), or the like. Incidentally, the simulation device is a driving simulator, a flight simulator or the like, for example. In VR, a Head Mounted Display (HMD), an immersive device or the like is used.

A user using a simulation device or experiencing VR can experience the state of riding a virtual mobile object. The virtual mobile object is a virtual automobile, a virtual airplane or the like, for example. In the following description, it is assumed that a virtual automobile moves in a virtual space.

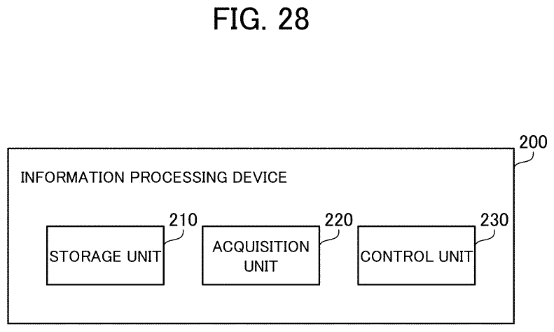

FIG. 28 is a block diagram showing function of an information processing device in the fourth embodiment. For example, the information processing device 200 may be installed in a simulation device. The information processing device 200 may be connected to a simulation device via a network. Further, the information processing device 200 may be connected to an HMD, for example.

The information processing device 200 is a device that executes a display method. The information processing device 200 includes a storage unit 210, an acquisition unit 220 and a control unit 230.

The storage unit 210 may be implemented as a storage area secured in a volatile storage device or a nonvolatile storage device included in the information processing device 200.

Part or all of the acquisition unit 220 and the control unit 230 may be implemented by a processor included in the information processing device 200. Part or all of the acquisition unit 220 and the control unit 230 may be implemented as modules of a program executed by the processor included in the information processing device 200. For example, the program is referred to also as a display program. The display program has been recorded in a record medium, for example.

The storage unit 210 stores the prediction information. The prediction information is information indicating whether or not the virtual automobile is scheduled to rotate at the first place in the virtual space. The prediction information may also be expressed as follows: The prediction information is information indicating whether or not the virtual automobile is scheduled to change moving direction or traveling direction at the first place in the virtual space.

The acquisition unit 220 acquires the prediction information from the storage unit 210. The acquisition unit 220 may acquire the prediction information from an external device connectable to the information processing device 200.

When the prediction information indicates that the virtual automobile is scheduled to rotate at the first place, the control unit 230 makes the display device display the motion sickness prevention information, moving in a direction based on a direction in which the virtual automobile is scheduled to rotate, before the virtual automobile reaches the first place. Here, the direction based on the direction in which the virtual automobile is scheduled to rotate is referred to also as the first direction.

For example, the motion sickness prevention information is a two-dimensional or three-dimensional figure shown in FIG. 4. The figure may either be a single figure or include a plurality of figures. Further, the control unit 230 may make the display device display information indicating scenery and the motion sickness prevention information. For example, the control unit 230 makes the display device display the motion sickness prevention information arranged in the scenery. Namely, the distance of displaying the motion sickness prevention information can be changed. The control unit 230 may also make the display device display two-dimensional motion sickness prevention information. Further, the control unit 230 may transform three-dimensional motion sickness prevention information to be displayed to two-dimensional motion sickness prevention information and make the display device display the two-dimensional motion sickness prevention information obtained by the transformation. Then, the two-dimensional motion sickness prevention information is displayed on a pillar of a cockpit provided in the VR space, the screen of a car navigation system, or the like. Here, the display device is a simulation device, an HMD or the like, for example.

The control unit 230 may also make the display device display the motion sickness prevention information moving in a direction opposite to the direction based on the direction in which the virtual automobile is scheduled to rotate.

Next, a process executed by the information processing device 200 will be described below by using a flowchart.

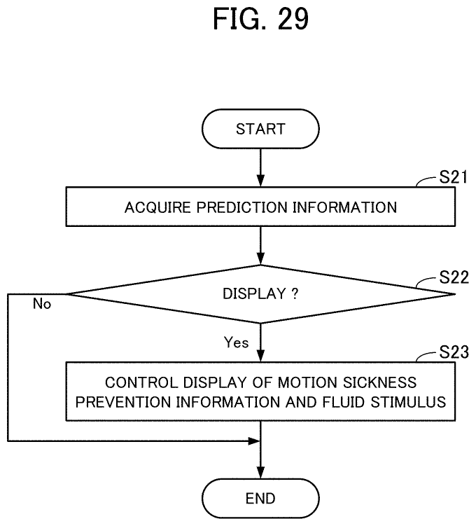

FIG. 29 is a flowchart showing an example of a process executed by the information processing device in the fourth embodiment. The process of FIG. 29 is executed periodically.

(Step S21) The acquisition unit 220 acquires the prediction information from the storage unit 210. The control unit 230 acquires the prediction information from the acquisition unit 220.

(Step S22) The control unit 230 judges whether or not the prediction information indicates that the virtual automobile is scheduled to rotate at the first place.

If the prediction information indicates that the virtual automobile is scheduled to rotate at the first place, the control unit 230 determines whether to display the motion sickness prevention information or not based on various threshold values. When the control unit 230 determines to display the motion sickness prevention information, the process advances to step S23. When the motion sickness prevention information is not displayed, the process ends.

(Step S23) Before the virtual automobile reaches the first place, the control unit 230 makes the display device display the fluid stimulus and the motion sickness prevention information moving in the direction based on the direction in which the virtual automobile is scheduled to rotate. Incidentally, the fluid stimulus is, for example, scenery obtained by the image capturing by a camera or virtual scenery based on computer graphics.

Accordingly, the display device displays the motion sickness prevention information superimposed on the fluid stimulus. Here, the control unit 230 may also make the display device display the motion sickness prevention information and the fluid stimulus in consideration of blend ratio between the fluid stimulus and the motion sickness prevention information.

In the first embodiment, the process is explained by using an automobile moving in a real space. In the fourth embodiment, a process similar to that in the first embodiment can be realized by replacing the real space with the virtual space. In other words, the features described with reference to FIGS. 7 to 22 are applicable to the fourth embodiment.

For example, the control unit 230 makes the display device display the motion sickness prevention information moving in a direction as a combination of the direction in which the virtual automobile is currently moving and the first direction or in a direction as a combination of the direction in which the virtual automobile is currently moving and the direction opposite to the first direction.

For example, the control unit 230 may make the display device display the motion sickness prevention information moving in the first direction or the opposite direction when the virtual automobile reaches the first place. The control unit 230 may also make the display device display the motion sickness prevention information moving in the first direction or the opposite direction after the virtual automobile passes through the first place.

For example, the control unit 230 may control the display device so as to increase the amount of the motion sickness prevention information in the first direction or the opposite direction.

For example, the control unit 230 may make the display device display the motion sickness prevention information moving in the first direction or the opposite direction according to a path of the motion sickness prevention information generated based on the route information on the virtual automobile.

For example, the control unit 230 may make the display device stop the displaying of the motion sickness prevention information after the virtual automobile passes through the first place.

For example, the control unit 230 may control the display device so as not to display the motion sickness prevention information in the central visual field of the user.

For example, the control unit 230 may control the display device so as not to display the motion sickness prevention information within a predetermined distance from the virtual automobile.

Further, for example, the prediction information acquired by the acquisition unit 220 indicates whether or not the virtual automobile is scheduled to rotate at the second place which is closer to the destination of the virtual automobile than the position indicating the corner situated at the first place and being the center of the range representing the first place. When the prediction information indicates that the virtual automobile is scheduled to rotate at the second place, a part of the range representing the first place overlaps with the range representing the second place, and the virtual automobile is situated in the overlapping range, the control unit 230 makes the display device display the motion sickness prevention information moving in the second direction based on the direction in which the virtual automobile is scheduled to rotate at the second place.

According to the fourth embodiment, the information processing device 200 makes the display device display the motion sickness prevention information having both meanings of the speed sense adjustment and the prediction information. Further, the information processing device 200 does not display the arrow indicating the traveling direction. Thus, the information processing device 200 mitigates the obstruction of the visual field. Accordingly, the information processing device 200 is capable of increasing the comfortability.

### Fifth Embodiment

Next, a fifth embodiment will be described below. In the fifth embodiment, the description will be given mainly of features different from those in the fourth embodiment. The description is omitted for features in common with the fourth embodiment. FIGS. 28 and 29 are referred to in the fifth embodiment.

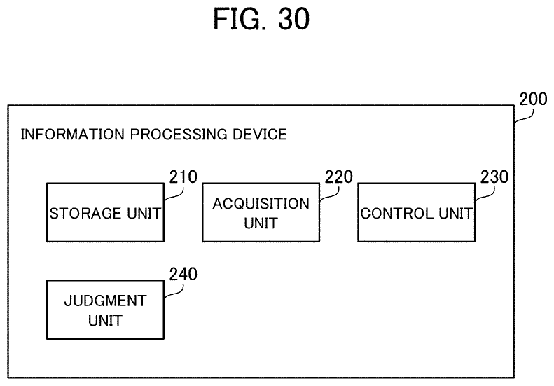

FIG. 30 is a block diagram showing function of an information processing device in the fifth embodiment. Each component in FIG. 30 being the same as a component shown in FIG. 28 is assigned the same reference character as in FIG. 28. The information processing device 200 further includes a judgment unit 240.

The judgment unit 240 judges a current motion sickness level of the user or a future motion sickness level of the user. The control unit 230 determines whether to display the motion sickness prevention information or not by using the current motion sickness level of the user or the future motion sickness level of the user.

First, a case of using the current motion sickness level will be described below.

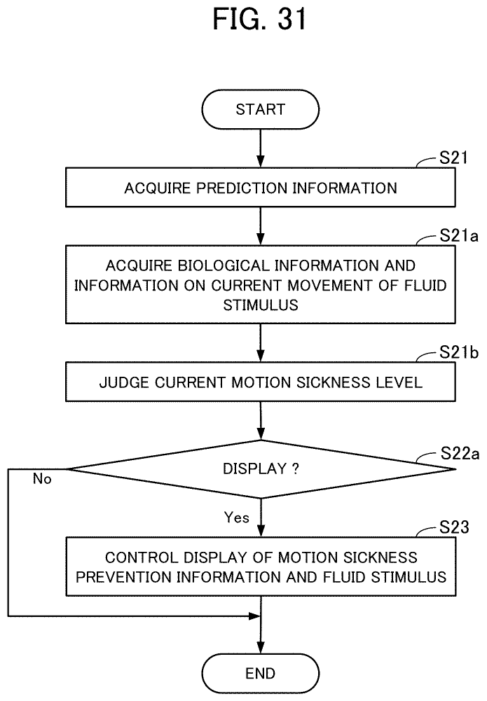

FIG. 31 is a flowchart showing an example of a judgment process using the current motion sickness level in the fifth embodiment. The process of FIG. 31 differs from the process of FIG. 29 in that steps S21a, S21b and S22a are executed. Thus, the steps S21a, S21b and S22a will be described below with reference to FIG. 31. In regard to the other steps in FIG. 31, the description of the processing is left out by assigning them the same step numbers as in FIG. 29.

(Step S21a) The acquisition unit 220 acquires biological information on the user via the biological information acquisition device. For example, the acquisition unit 220 acquires the biological information as described in the second embodiment. Further, the acquisition unit 220 may acquire information including past biological information and current biological information. Furthermore, the acquisition unit 220 may acquire the result of analysis of the biological information. Incidentally, the analysis of the biological information is executed by the information processing device 200 or a device other than the information processing device 200.

Further, the acquisition unit 220 acquires information indicating the current movement of the fluid stimulus in the virtual space from the storage unit 210. Incidentally, the information indicating the current movement of the fluid stimulus is information indicating a direction opposite to the direction in which the virtual automobile is currently moving in the virtual space. The acquisition unit 220 may also acquire information including information indicating past movement of the fluid stimulus and the information indicating the current movement of the fluid stimulus.

(Step S21b) The judgment unit 240 judges the current motion sickness level based on the biological information and the information indicating the current movement of the fluid stimulus. When judging the current motion sickness level, the judgment unit 240 may judge the current motion sickness level by using judgment information as information for judging the current motion sickness level. Incidentally, the judgment information is, for example, learning data obtained by machine learning. The judgment unit 240 may also judge the current motion sickness level by means of machine learning. By use of the machine learning, the accuracy of the motion sickness level calculation can be increased.

Here, it is also possible to execute the steps 21a and 21b before the step S21 or in parallel with the step S21.

(Step S22a) The control unit 230 judges whether or not the prediction information indicates that the virtual automobile is scheduled to rotate at the first place and the current motion sickness level is higher than or equal to a predetermined threshold value.

If the conditions in the step S22a are satisfied, the control unit 230 determines to display the motion sickness prevention information. Namely, if the prediction information indicates that the virtual automobile is scheduled to rotate at the first place and the current motion sickness level is higher than or equal to the threshold value, the control unit 230 determines to display the motion sickness prevention information. Then, the process advances to the step S23.

If the conditions in the step 22a are not satisfied, the process ends.

Incidentally, the motion sickness level calculation, the threshold value calculation and the display propriety judgment may also be executed at once. Namely, the display propriety may be judged by executing the processes of the step S21b and the step S22a at once by use of machine learning or the like. By use of the machine learning, the accuracy of the motion sickness level calculation can be increased.

As above, the information processing device 200 displays the motion sickness prevention information when the user is suffering from the motion sickness. In conclusion, the information processing device 200 is capable of preventing the user from worsening the condition of the motion sickness.

Further, after displaying the motion sickness prevention information, the information processing device 200 may stop the displaying of the motion sickness prevention information when the current motion sickness level falls below the threshold value.

Next, a case of using the future motion sickness level will be described below.

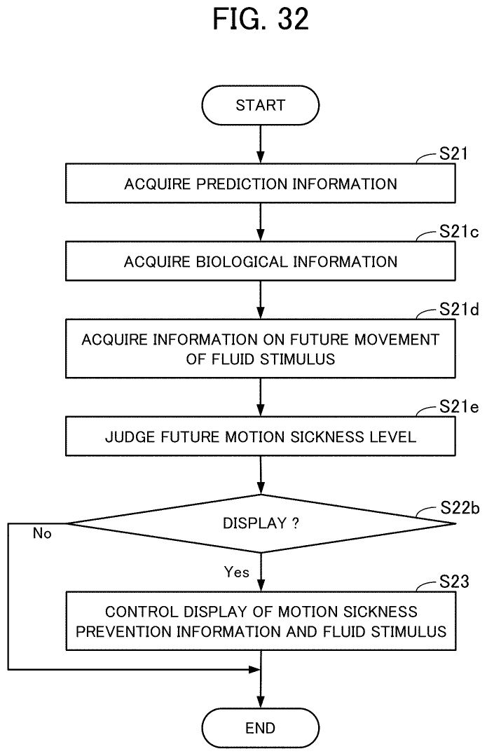

FIG. 32 is a flowchart showing an example of a judgment process using the future motion sickness level in the fifth embodiment. The process of FIG. 32 differs from the process of FIG. 29 in that steps S21c, S21d, S21e and S22b are executed. Thus, the steps S21c, S21d, S21e and S22b will be described below with reference to FIG. 32. In regard to the other steps in FIG. 32, the description of the processing is left out by assigning them the same step numbers as in FIG. 29.

(Step S21c) The acquisition unit 220 acquires the biological information on the user via the biological information acquisition device. The acquisition unit 220 may also acquire information including past biological information and current biological information. Further, the acquisition unit 220 may acquire the result of analysis of the biological information. Incidentally, the analysis of the biological information is executed by the information processing device 200 or a device other than the information processing device 200.

(Step S21d) The acquisition unit 220 acquires information indicating the future movement of the fluid stimulus in the virtual space from the storage unit 210. Specifically, this information is information indicating a direction opposite to a direction in which the virtual automobile is scheduled to move at the first place in the virtual space.

(Step S21e) The judgment unit 240 judges the future motion sickness level based on the biological information and the information indicating the future movement of the fluid stimulus. When judging the future motion sickness level, the judgment unit 240 may judge the future motion sickness level by using judgment information as information for judging the future motion sickness level. Incidentally, the judgment information is, for example, learning data obtained by machine learning. The judgment unit 240 may also judge the future motion sickness level by means of machine learning. By use of the machine learning, the accuracy of the motion sickness level calculation can be increased.

Here, it is also possible to execute the steps S21c, S21d and S21e before the step S21 or in parallel with the step S21.

(Step S22b) The control unit 230 judges whether or not the prediction information indicates that the virtual automobile is scheduled to rotate at the first place and the future motion sickness level is higher than or equal to a predetermined threshold value.

If the conditions in the step S22b are satisfied, the control unit 230 determines to display the motion sickness prevention information. Namely, if the prediction information indicates that the virtual automobile is scheduled to rotate at the first place and the future motion sickness level is higher than or equal to the threshold value, the control unit 230 determines to display the motion sickness prevention information. Then, the process advances to the step S23.

If the conditions in the step S22b are not satisfied, the process ends.

Incidentally, the motion sickness level calculation, the threshold value calculation and the display propriety judgment may also be executed at once. Namely, the display propriety may be judged by executing the processes of the step S21e and the step S22b at once by use of machine learning or the like. By use of the machine learning, the accuracy of the motion sickness level calculation can be increased.

As above, the information processing device 200 makes the display device display the motion sickness prevention information before the user suffers from the motion sickness. In conclusion, the information processing device 200 is capable of preventing the user from suffering from the motion sickness.

### Sixth Embodiment

Next, a sixth embodiment will be described below. In the sixth embodiment, the description will be given mainly of features different from those in the fourth embodiment. The description is omitted for features in common with the fourth embodiment. FIGS. 28 and 29 are referred to in the sixth embodiment.

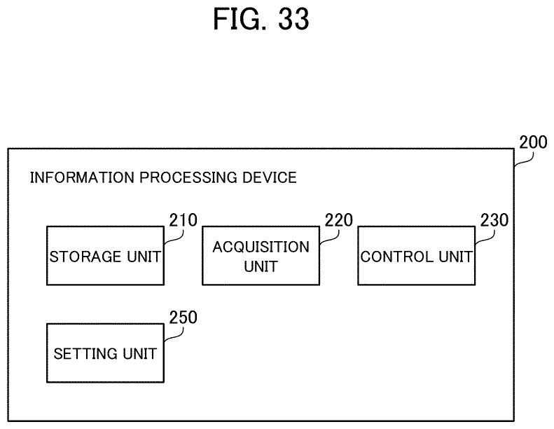

FIG. 33 is a block diagram showing function of an information processing device in the sixth embodiment. Each component in FIG. 33 being the same as a component shown in FIG. 28 is assigned the same reference character as in FIG. 28. The information processing device 200 further includes a setting unit 250.

The setting unit 250 sets the display region of the motion sickness prevention information. The control unit 230 controls the display device so as to display the motion sickness prevention information in the display region. Further, the control unit 230 may control the display device so as to separate the display region of the motion sickness prevention information and a display region of the fluid stimulus from each other. Namely, the control unit 230 may control the display device so as not to display the motion sickness prevention information and the fluid stimulus in the same region.

The sixth embodiment will be described concretely below. For example, the setting unit 250 sets a part of the user's central visual field as the display region of the motion sickness prevention information. Further, for example, the setting unit 250 sets a plurality of regions as the display regions of the motion sickness prevention information.

Incidentally, the timing for the setting unit 250 to set the display region of the motion sickness prevention information can be any time as long as it is before the control unit 230 has the motion sickness prevention information displayed.

According to the sixth embodiment, the information processing device 200 is capable of setting the display region of the motion sickness prevention information. Further, the fourth to sixth embodiments may be combined together.

Features in the embodiments described above can be appropriately combined with each other.

### DESCRIPTION OF REFERENCE CHARACTERS

11: windshield, 12: liquid crystal display, 21: automobile, 22: route, 23a: place, 23b: place, 23c: place, 24a: path, 25: circle, 26a: range, 26b: range, 27a: range, 27b: range, 28a: range, 28b: range, 29: display range, 31: route, 32: path, 33a: place, 33b: place, 34a: range, 34b: range, 41: route, 42: path, 43a: place, 43b: place, 44a: range, 44b: range, 45a: range, 45b: range, 51: route, 52: path, 53a: place, 53b: place, 53c: place, 54a: range, 54b: range, 55a: range, 55b: range, 56a: range, 56b: range, 61: route, 62: path, 63a: place, 63b: place, 64a: range, 64b: range, 71: route, 72: path, 73a: place, 73b: place, 74a: range, 74b: range, 75a: range, 75b: range, 81, 82: display range, 91: route, 92, 93: path, 94, 95: display range, 96, 97: region, 100: information processing device, 101: processor, 102: volatile storage device, 103: nonvolatile storage device, 104: bus, 110: storage unit, 120: current condition information generation unit, 130: prediction information generation unit, 140: acquisition unit, 150: control unit, 160: judgment unit, 170: setting unit, 200: information processing device, 210: storage unit, 220: acquisition unit, 230: control unit, 240: judgment unit, 250: setting unit, 301: windshield, 311: frame, 312: frame, 321: automobile, 322: range, 323: point, 324: range, 325: point, 331: windshield, 332: range, 333: range

What is claimed is:

1. An information processing device comprising:
an acquiring circuitry to acquire prediction information indicating whether or not a mobile object is scheduled to rotate at a first place; and
a controlling circuitry to make a display device display motion sickness prevention information moving in a first direction based on a direction in which the mobile object is scheduled to rotate or in a direction opposite to the first direction before the mobile object reaches the first place when the prediction information indicates that the mobile object is scheduled to rotate at the first place.

2. The information processing device according to claim 1, wherein the controlling circuitry makes the display device display the motion sickness prevention information moving in a direction as a combination of a direction in which the mobile object is currently moving and the first direction or in a direction as a combination of the direction in which the mobile object is currently moving and the opposite direction.

3. The information processing device according to claim 1, wherein the controlling circuitry makes the display device display the motion sickness prevention information moving in the first direction or the opposite direction when the mobile object reaches the first place or after the mobile object passes through the first place.

4. The information processing device according to claim 1, wherein the controlling circuitry controls the display device so as to increase an amount of the motion sickness prevention information in the first direction or the opposite direction.

5. The information processing device according to claim 1, wherein the controlling circuitry makes the display device display the motion sickness prevention information moving in the first direction or the opposite direction according to a path of the motion sickness prevention information generated based on route information on the mobile object.

6. The information processing device according to claim 5, wherein the controlling circuitry generates the path of the motion sickness prevention information by performing affine transformation on a part of the route of the mobile object.

7. The information processing device according to claim 1, wherein the controlling circuitry makes the display device display the motion sickness prevention information while changing a display distance of the motion sickness prevention information.

8. The information processing device according to claim 1, wherein the controlling circuitry makes the display device display two-dimensional motion sickness prevention information or transforms three-dimensional motion sickness prevention information to be displayed to two-dimensional motion sickness prevention information and makes the display device display the two-dimensional motion sickness prevention information obtained by the transformation.

9. The information processing device according to claim 1, wherein
the prediction information indicates whether or not the mobile object is scheduled to rotate at a second place that is closer to a destination of the mobile object than a position indicating a corner situated at the first place, and
when the prediction information indicates that the mobile object is scheduled to rotate at the second place, a part of a range representing the first place overlaps with a range representing the second place, and the mobile object is situated in the overlapping range, the controlling circuitry makes the display device display the motion sickness prevention information moving in a second direction based on a direction in which the mobile object is scheduled to rotate at the second place.

10. The information processing device according to claim 1, further comprising a jugging circuitry, wherein
the acquiring circuitry acquires biological information and information indicating a direction opposite to a direction in which the mobile object is currently moving,
the jugging circuitry judges a motion sickness level based on the biological information and the information indicating the direction opposite to the direction in which the mobile object is currently moving, and
when the prediction information indicates that the mobile object is scheduled to rotate at the first place and the motion sickness level is higher than or equal to a predetermined threshold value, the controlling circuitry makes the display device display the motion sickness prevention information moving in the first direction or the direction opposite to the first direction before the mobile object reaches the first place.

11. The information processing device according to claim 1, further comprising a jugging circuitry, wherein
the acquiring circuitry acquires biological information and information indicating a direction opposite to a direction in which the mobile object is scheduled to move at the first place,
the jugging circuitry judges a motion sickness level based on the biological information and the information indicating the direction opposite to the direction in which the mobile object is scheduled to move at the first place, and
when the prediction information indicates that the mobile object is scheduled to rotate at the first place and the motion sickness level is higher than or equal to a predetermined threshold value, the controlling circuitry makes the display device display the motion sickness prevention information moving in the first direction or the direction opposite to the first direction before the mobile object reaches the first place.

12. The information processing device according to claim 10, wherein the jugging circuitry determines the motion sickness level by use of machine learning.

13. The information processing device according to claim 1, wherein the controlling circuitry determines whether to display the motion sickness prevention information or not by use of machine learning.

14. The information processing device according to claim 1, wherein the controlling circuitry displays the motion sickness prevention information within a predetermined distance from the mobile object or the first place.

15. The information processing device according to claim 1, wherein the controlling circuitry controls the display device so as not to display the motion sickness prevention information in a central visual field of a passenger situated in the mobile object.

16. The information processing device according to claim 1, wherein the controlling circuitry controls the display device so as not to display the motion sickness prevention information within a predetermined distance from the mobile object.

17. The information processing device according to claim 1, wherein the controlling circuitry makes the display device stop the displaying of the motion sickness prevention information after the mobile object passes through the first place.

18. The information processing device according to claim 1, wherein
the mobile object is a virtual mobile object,
the prediction information indicates whether or not the virtual mobile object is scheduled to rotate at the first place in a virtual space, and
when the prediction information indicates that the virtual mobile object is scheduled to rotate at the first place, the controlling circuitry makes the display device display the motion sickness prevention information moving in the first direction based on the direction in which the virtual mobile object is scheduled to rotate or in the opposite direction before the virtual mobile object reaches the first place.

19. The information processing device according to claim 18, wherein the controlling circuitry makes the display device display the motion sickness prevention information moving in a direction as a combination of a direction in which the virtual mobile object is currently moving and the first direction or in a direction as a combination of the direction in which the virtual mobile object is currently moving and the opposite direction.

20. The information processing device according to claim 18, wherein the controlling circuitry makes the display device display the motion sickness prevention information moving in the first direction or the opposite direction when the virtual mobile object reaches the first place or after the virtual mobile object passes through the first place.

21. The information processing device according to claim 18, wherein the controlling circuitry controls the display device so as to increase an amount of the motion sickness prevention information in the first direction or the opposite direction.

22. The information processing device according to claim 18, wherein the controlling circuitry makes the display device display the motion sickness prevention information moving in the first direction or the opposite direction according to a path of the motion sickness prevention information generated based on route information on the virtual mobile object.

23. The information processing device according to claim 22, wherein the controlling circuitry generates the path of the motion sickness prevention information by performing affine transformation on a part of the route of the virtual mobile object.

24. The information processing device according to claim 18, wherein
the prediction information indicates whether or not the virtual mobile object is scheduled to rotate at a second place that is closer to a destination of the virtual mobile object than a position indicating a corner situated at the first place, and
when the prediction information indicates that the virtual mobile object is scheduled to rotate at the second place, a part of a range representing the first place overlaps with a range representing the second place, and the virtual mobile object is situated in the overlapping range, the controlling circuitry makes the display device display the motion sickness prevention information moving in a second direction based on a direction in which the virtual mobile object is scheduled to rotate at the second place.

25. The information processing device according to claim 18, wherein the controlling circuitry makes the display device display information indicating scenery and the motion sickness prevention information.

26. The information processing device according to claim 18, wherein the controlling circuitry makes the display device display the motion sickness prevention information while changing a display distance of the motion sickness prevention information.

27. The information processing device according to claim 18, wherein the controlling circuitry makes the display device display two-dimensional motion sickness prevention information or transforms three-dimensional motion sickness prevention information to be displayed to two-dimensional motion sickness prevention information and makes the display device display the two-dimensional motion sickness prevention information obtained by the transformation.

28. The information processing device according to claim 18, further comprising a jugging circuitry, wherein
the acquiring circuitry acquires biological information and information indicating a direction opposite to a direction in which the virtual mobile object is currently moving in the virtual space,
the jugging circuitry judges a motion sickness level based on the biological information and the information indicating the direction opposite to the direction in which the virtual mobile object is currently moving in the virtual space, and
when the prediction information indicates that the virtual mobile object is scheduled to rotate at the first place and the motion sickness level is higher than or equal to a predetermined threshold value, the controlling circuitry makes the display device display the motion sickness prevention information moving in the first direction or the direction opposite to the first direction before the virtual mobile object reaches the first place.

29. The information processing device according to claim 18, further comprising a jugging circuitry, wherein
the acquiring circuitry acquires biological information and information indicating a direction opposite to a direction in which the virtual mobile object is scheduled to move at the first place in the virtual space,
the jugging circuitry judges a motion sickness level based on the biological information and the information indicating the direction opposite to the direction in which the virtual mobile object is scheduled to move at the first place in the virtual space, and
when the prediction information indicates that the virtual mobile object is scheduled to rotate at the first place and the motion sickness level is higher than or equal to a predetermined threshold value, the controlling circuitry makes the display device display the motion sickness prevention information moving in the first direction or the direction opposite to the first direction before the virtual mobile object reaches the first place.

30. The information processing device according to claim 28, wherein the jugging circuitry determines the motion sickness level by use of machine learning.

31. The information processing device according to claim 18, wherein the controlling circuitry determines whether to display the motion sickness prevention information or not by use of machine learning.

32. The information processing device according to claim 18, wherein the controlling circuitry controls the display device so as not to display the motion sickness prevention information in a central visual field of a user.

33. The information processing device according to claim 18, wherein the controlling circuitry controls the display device so as not to display the motion sickness prevention information within a predetermined distance from the virtual mobile object.

34. The information processing device according to claim 18, wherein the controlling circuitry makes the display device stop the displaying of the motion sickness prevention information after the virtual mobile object passes through the first place.

35. The information processing device according to claim 1, further comprising a setting circuitry to set a display region of the motion sickness prevention information,
wherein the controlling circuitry controls the display device so as to display the motion sickness prevention information moving in the first direction or the opposite direction in the display region.

36. A display method performed by an information processing device, the display method comprising:
acquiring prediction information indicating whether or not a mobile object is scheduled to rotate at a first place; and
making a display device display motion sickness prevention information moving in a first direction based on a direction in which the mobile object is scheduled to rotate or in a direction opposite to the first direction before the mobile object reaches the first place when the prediction information indicates that the mobile object is scheduled to rotate at the first place.

37. An information processing device comprising:
a processor to execute a program; and
a memory to store the program which, when executed by the processor, performs processes of,
acquiring prediction information indicating whether or not a mobile object is scheduled to rotate at a first place; and
making a display device display motion sickness prevention information moving in a first direction based on a direction in which the mobile object is scheduled to rotate or in a direction opposite to the first direction before the mobile object reaches the first place when the prediction information indicates that the mobile object is scheduled to rotate at the first place.
